(19) United States
(12) Patent Application Publication
(10) Pub. No.: US 2025/0043052 A1
(43) Pub. Date: Feb. 6, 2025

(54) PROCESS FOR PREPARING AN AQUEOUS POLYMER DISPERSION

(71) Applicant: BASF SE, Ludwigshafen am Rhein (DE)

(72) Inventors: Bastiaan LOHMEIJER, Ludwigshafen am Rhein (DE); Konrad ROSCHMANN, Ludwigshafen am Rhein (DE); Guenter ULPINS, Ludwigshafen am Rhein (DE)

(21) Appl. No.: 18/718,076

(22) PCT Filed: Dec. 14, 2022
(86) PCT No.: PCT/EP2022/085845

§ 371 Date: Jun. 10, 2024

(30) Foreign Application Priority Data
Dec. 15, 2021 (EP) 21214768.0

(51) Int. Cl. C08F 220/14; C09D 133/12

(52) U.S. Cl. CPC C08F 220/14; C09D 133/12; C08F 2800/20

(57) ABSTRACT

The present invention relates to a process for preparing an aqueous polymer dispersion having a polymer content of at least 50 weight-% based on the total weight of the aqueous polymer dispersion, the process comprising preparing a stabilizer dispersion having a pH in the range of from 0 to 5; preparing said aqueous polymer. The present invention further relates to an aque-ous polymer dispersion obtained or obtainable by said process, use of said dispersion as well as a coating composition comprising said dispersion.

The present invention relates to a process for preparing an aqueous polymer dispersion, an aqueous polymer dispersion and the use of said dispersion as a binder. Further, the present invention relates to a coating composition comprising said dispersion.

Polymer dispersions stabilized by protective colloids (also known as alkali-soluble resin supported emulsion polymers or RC emulsions) are generally provided at a solids content of 45 wt. % or even lower. At higher solids contents of more than 50 wt. % or more than 55 wt. %, for example, they often exhibit the disadvantage of poor rheological properties and are too highly viscous or no longer sufficiently fluid for being handled either during latex manufacture or when formulated into paints. Yet, in view of a restricted water-household in certain coatings formulations as well as in terms of improved space/time yield in latex production as well as lower transport costs per kg active and, thus, a more benign carbon footprint there is a need to provide high-solid content, protective-colloid stabilized polymer dispersions with acceptable viscosity and rheology properties. In addition, the higher solid of the binder opens up new formulation space to increase the solids content of the formulation at acceptable rheology. This in turn would lead to a reduction of the amount of carrier medium (water and/or coalescents) to be evaporated resulting in further benefits in carbon footprint. In the best of cases it may furthermore allow for faster development of mechanical properties with increases in throughput and overall efficiency, especially in industrial coatings applications.

EP3194454 B1 discloses fine-sized aqueous emulsion polymers und their use for hydrophobic coatings on wooden substrates. The latex polymers described therein are synthesized in a two-staged process where in a first step an alkali-soluble resin is manufactured and dissolved by addition of an aqueous ammonia solution and a soft, hydrophobic polymer-phase is polymerized subsequently. To provide good block-resistance of coatings formulated therewith, there is a substantial amount of hard, first-stage polymer (32.5 wt. % in the examples). Yet, all examples are in the conventional, low solids regime of ≤45 wt. %.

EP3670552 A1 discloses an alkali-soluble resin supported emulsion polymer composition having a bimodal or a polymodal particle size distribution and alkali soluble resins suitable for producing these polymers. Whereas most examples are in the conventional, low solids regime of ≤45 wt. %, two trials are higher in solids content and indicate that low viscosities at high-solids may be obtained. However, the underlying working principle, namely adjusting a certain acid-number for the alkali-soluble resin, seems to be rather case-sensitive and gives no hope for broad applicability of the described method.

WO2014/053410 A1 discloses a process for preparing an aqueous polymer dispersion based on (meth)acrylate ester monomers, with high solid content, the preparation taking place in presence of protective colloids and preferably in emulsifier-free form. However, the amount of protective colloid which is used to prepare the aqueous polymer dispersion is not high enough for using the dispersion as binder in architectural or industrial coatings. Further, the feed profile for the addition of the protective colloid as well as for the monomer emulsion could be simplified.

Therefore, there is a need to provide an improved, highly efficient process for preparing an aqueous polymer dispersion which exhibits high solid content and comprises enough stabilizer dispersion (protective colloid) to provide good coating properties such as low whitening, fast drying and high blocking resistance when used as binders in architectural and industrial coatings. It was surprisingly found that the process for preparing an aqueous polymer dispersion according to the present invention permits to achieve such objectives.

Therefore, the present invention relates to a process for preparing an aqueous polymer dispersion having a polymer content of at least 50 weight-% based on the total weight of the aqueous polymer dispersion, the process comprising
(i) preparing a stabilizer dispersion, comprising subjecting ethylenically unsaturated monomers comprising monomers which exhibit a Bronsted acidic group and further comprising monomers which do not exhibit a Bronsted acidic group, to co-polymerization in water, obtaining said stabilizer dispersion having a pH in the range of from 0 to 5;
(ii) preparing said aqueous polymer dispersion, comprising
   (ii.1) preparing an aqueous mixture comprising water and ethylenically unsaturated monomers which do not exhibit a Bronsted acidic group;
   (ii.2) introducing said aqueous mixture as a first feed into a polymerization vessel and subjecting the monomers comprised in said aqueous mixture to co-polymerization in said polymerization vessel;
   (ii.3) introducing the stabilizer dispersion obtained according to (i) as a second feed and a base into the polymerization vessel comprising at least a portion of said aqueous mixture, obtaining said aqueous polymer dispersion;
wherein the polymer particles of the aqueous polymer dispersion obtained according to (ii) exhibit a polymodal particle size distribution;
wherein at least 95 weight-% of the polymers comprised in the aqueous polymer dispersion are based on the monomers employed according to (i) and (ii).

### Stabilizer Dispersion Preparation

Preferably, (i) comprises
(i. 1) preparing a mixture of water and a surfactant under an inert gas atmosphere;
(i.2) admixing the mixture prepared according to (i.1) with an aqueous monomer mixture comprising water and ethylenically unsaturated monomers comprising monomers which exhibit a Bronsted acidic group and further comprising monomers which do not exhibit a Bronsted acidic group;
(i.3) subjecting the aqueous mixture obtained according to (i.2) to co-polymerization.

Preferably (i) consists of (i.1) and (i.2) and (i.3).

Preferably the surfactant used in (i.1) is an emulsifier comprising, more preferably consisting of, one or more of branched or linear unsaturated alkyl alkoxysulfonates, branched unsaturated alkyl alkoxysulfates, branched unsaturated alkyl alkoxyphosphates and branched unsaturated alkylphosphonates, more preferably branched unsaturated alkyl alkoxysulfates.

For example, the emulsifier can preferably be at least one anionic copolymerizable emulsifier, being more preferably selected from the group consisting of
(1) a compound of formula (I)

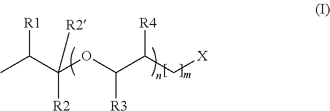

wherein R1 is H, alkyl, cycloalkyl, aralkyl, aryl, or alkoxyaryl, R2, R2′ is-H or R2 and R2′ are O, R3 is H or alkyl, R4 is H or OH, X is SO₃⁻, SO₄⁻, HPO₄⁻, PO₄²⁻, or COO⁻, m is 0 or 1, and n is an integer in the range of from 1 to 1000, more preferably in the range of from 1 to 500, most preferably in the range of from 4 to 50;
(2) a compound of formula (II)

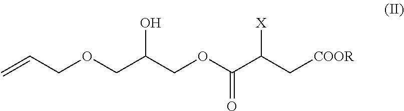

wherein X is SO₃⁻, PO₄²⁻, or SO₄⁻, and R is H, alkyl cycloalkyl, aralkyl, aryl or alkoxyaryl; (3) a compound of formula (IIIa) or (IIIb)

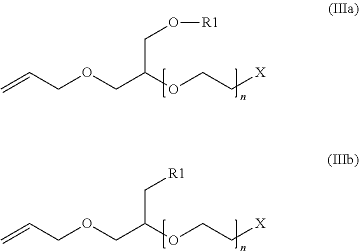

wherein R1 is H, alkyl, cycloalkyl, aralkyl aryl or alkoxyaryl, X is SO₄⁻, SO₃⁻, HPO₄⁻, PO₄²⁻, or COO⁻, n is an integer in the range of from 1 to 1000, more preferably in the range of from 1 to 500, most preferably in the range of from 4 to 50;
(4) a compound of the formula (IV)

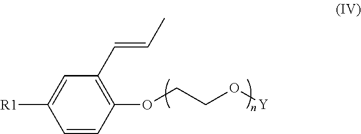

wherein R1 is H, alkyl, cycloalkyl, aralkyl, aryl, or alkoxyaryl, Y is SO₃⁻, PHO₃⁻, or PO₃²⁻, and n is an integer in the range of from 1 to 1000, more preferably in the range of from 1 to 500, most preferably in the range of from 4 to 50;
or mixtures of the compounds of the formulae (I) to (IV).

The anionic copolymerizable emulsifiers may be present in neutralized form. The counterion present for the anionic groups X and/or Y can preferably be a cation selected from the group consisting of Li⁺, Na⁺, K⁺, Ca²⁺, NH₄⁺, and mixtures thereof, more preferably NH₄⁺ or Na⁺.

A non-exhaustive list of suitable anionic copolymerizable emulsifiers comprises Adeka Reasoap SR-10, SR-1025, SR-20 and SR-3025 (compounds of formula IIIa), Adeka Reasoap SE-10N, SE-1025A and SE-20N (compounds of formula IIIa), Hitenol KH-05, KH-0530, KH-10 and KH-1025 (compounds of formula IIIb) and Hitenol BC-10, BC-1025, BC-20, BC-2020 and BC-30 (compounds of formula IV).

In the context of the present invention, preparing a mixture according to (i.1) is preferably performed in the inert gas atmosphere having a temperature in the range of from 15 to 30° C., more preferably in the range of from 20 to 25° C. In other words, (i.1) is preferably performed in the inert gas atmosphere at room temperature.

Preferably admixing according to (i.2) is performed at a temperature in the range of from 15 to 35° C., more preferably in the range of from 18 to 30° C., more preferably in the range of from 20 to 25° C. In other words, admixing according to (i.2) is performed at room temperature.

Preferably (i.1) further comprises admixing an inorganic additive mixture. For example, the inorganic additive is more preferably an aqueous tetra-sodium pyrophosphate solution.

In the context of the present invention, the inert gas atmosphere is preferably a nitrogen gas atmosphere.

### Monomers Comprised in the Aqueous Monomer Mixture Used in (i.2)

Preferably Tg(S) is of at least 50° C., preferably in the range of from 50 to 150° C., more preferably in the range of from 70 to 125° C., more preferably in the range of from 80 to 100° C., Tg(S) being the theoretical glass transition temperature (Tg) of the polymer which would be obtained from polymerization of the monomers of the aqueous monomer mixture used in (i.2), wherein said theoretical glass transition temperatures Tg(S) is determined according to the Fox equation.

### Acidic Monomers

Preferably the monomers which exhibit a Bronsted acidic group comprised in the aqueous monomer mixture used in (i.2) are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof, more preferably monoethylenically unsaturated monocarboxylic acids having 3 to 6 carbon atoms.

Preferably the monoethylenically unsaturated monocarboxylic acids having 3 to 6 carbon atoms are one or more of methacrylic acids, acrylic acids, crotonic acids, 2-ethylpropenoic acids, 2-propylpropenoic acids, 2-acryloxyacetic acids and 2-methacyloxyacetic acids, preferably one or more of methacrylic acids and acrylic acids, more preferably methacrylic acids.

Preferably, alternatively, the monoethylenically unsaturated dicarboxylic acids having 4 to 6 carbon atoms are one or more of itaconic acids, maleic acids and fumaric acids.

More preferably the monomers which exhibit a Bronsted acidic group comprised in the aqueous monomer mixture used in (i.2) are methacrylic acids.

Preferably the total amount of monomers which exhibit a Bronsted acidic group comprised in the aqueous mixture obtained according to (i.2) is in the range of from 0.5 to 10 weight-%, more preferably in the range of from 1 to 8 weight-%, more preferably in the range of from 3 to 7 weight-%, more preferably in the range of from 4 to 6 weight-%, based on the total weight of the aqueous mixture obtained according to (i.2).

Preferably the total amount of monomers which exhibit a Bronsted acidic group comprised in the aqueous monomer mixture used in (i.2) is in the range of from 1 to 15 pphm (parts per hundred monomers), more preferably in the range of from 5 to 13 pphm, more preferably in the range of from 6 to 12 pphm, more preferably in the range of from 8 to 11 pphm based on the total amount of monomers used in (i.2). Here, “pphm” refers to parts per hundred monomers, this permits to evaluate the amount of the monomers, which exhibit a Bronsted acidic group comprised in the aqueous monomer mixture used in (i.2), in the monomer mixture (i.2) relative to 100 parts of the monomers forming the monomer mixture (i.2). It is noted that such amount may equally be defined in weight-% based on monomer “wt. % b.o.m”.

### Other Monomers

Preferably the monomers which do not exhibit a Bronsted acidic group comprised in the aqueous monomer mixture used in (i.2) comprises one or more of esters of acrylic acid and esters of methacrylic acid, preferably esters of acrylic acid and esters of methacrylic acid.

Preferably the esters of acrylic acid are one or more of C₁-C₁₂ alkyl esters of acrylic acid, C₅-C₂₀ cycloalkyl esters of acrylic acid and C₅-C₂₀ cycloalkylmethyl esters of acrylic acid, preferably one or more of C₁-C₁₂ alkyl esters of acrylic acid and C₅-C₂₀ cycloalkyl esters of acrylic acid, more preferably one or more of C₂-C₁₀ alkyl esters of acrylic acid and C₅-C₂₀ cycloalkyl esters of acrylic acid. It is noted that the cycloalkyl in the aforementioned monomers can preferably be mono-, bi- or tricyclic and wherein 1 or 2 nonadjacent CH₂ moieties of the cycloalkyl may be replaced by oxygen atoms. The cycloalkyl can preferably be unsubstituted or carry 1, 2, 3 or 4 methyl groups, and mono-vinyl aromatic monomers, such as styrene and styrenic derivatives.

Examples of suitable styrenic derivatives include styrene substituted with 1 or 2 substituents selected from the group consisting of halogen, OH, CN, NO₂, phenyl and C₁-C₄-alkyl, such as vinyltoluene, alpha-methylstyrene, ethylstyrene, isopropylstyrene, tert-butylstyrene, 2,4-dimethylstyrene, diethylstyrene, o-methyl-isopropylstyrene, chlorostyrene, fluorostyrene, iodostyrene, bromostyrene, 2,4-cyanostyrene, hydroxystyrene, nitrostyrene or phenylstyrene. The preferred mono-vinylaromatic hydrocarbon monomer is styrene.

Preferably the esters of methacrylic acid are one or more of C₁-C₁₂ alkyl esters of methacrylic acid, C₅-C₂₀ cycloalkyl esters of methacrylic acid and C₅-C₂₀ cycloalkylmethyl esters of methacrylic acid, more preferably one or more of C₁-C₁₂ alkyl esters of methacrylic acid and C₅-C₂₀ cycloalkyl esters of methacrylic acid, more preferably one or more of C₁-C₁₀ alkyl esters of methacrylic acid and C₅-C₂₀ cycloalkyl esters of methacrylic acid. It is noted that the cycloalkyl in the aforementioned monomers can preferably be mono-, bi- or tricyclic and wherein 1 or 2 nonadjacent CH₂ moieties of the cycloalkyl may be replaced by oxygen atoms. The cycloalkyl can preferably be unsubstituted or carry 1, 2, 3 or 4 methyl groups, and mono-vinyl aromatic monomers, such as styrene and styrenic derivatives.

More preferably the monomers which do not exhibit a Bronsted acidic group comprised in the aqueous monomer mixture used in (i.2) comprises one or more of C₂-C₁₀ alkyl ester of acrylic acid and C₅-C₂₀ cycloalkyl ester of acrylic acid, wherein said monomers are selected from the group consisting of ethyl acrylate, n-butyl acrylate, iso-butyl acrylate, tert-butyl acrylate, n-hexyl acrylate, n-octyl acrylate, 2-ethylhexyl acrylate, 2-octyl acrylate, isobornyl acrylate and a mixture of two or more thereof, more preferably selected from the group consisting of n-butyl acrylate, iso-butyl acrylate, tert-butyl acrylate, n-octyl acrylate and 2-ethylhexyl acrylate, more preferably is n-butyl acrylate.

Preferably the total amount of the one or more of C₂-C₁₀ alkyl ester of acrylic acid and C₅-C₂₀ cycloalkyl ester of acrylic acid in the aqueous monomer mixture used in (i.2) is in the range of from 1 to 15 pphm, more preferably in the range of from 5 to 13 pphm, more preferably in the range of from 6 to 12 pphm, more preferably in the range of from 8 to 11 pphm based on the total amount of monomers used in (i.2). Here, “pphm” refers to parts per hundred monomers, this permits to evaluate the amount of the monomers, namely of the one or more of C₂-C₁₀ alkyl ester of acrylic acid and C₅-C₂₀ cycloalkyl ester of acrylic acid in the aqueous monomer mixture used in (i.2), in the monomer mixture (i.2) relative to 100 parts of the monomers forming the monomer mixture (i.2).

More preferably the monomers which do not exhibit a Bronsted acidic group comprised in the aqueous monomer mixture used in (i.2) comprises one or more of C₁-C₁₀ alkyl ester of methacrylic acid and C₅-C₂₀ cycloalkyl ester of methacrylic acid, wherein the monomers are selected from the group consisting of methyl methacrylate, ethyl methacrylate, propyl methacrylate, n-butyl methacrylate, iso-butyl methacrylate, tert-butyl methacrylate, cyclohexyl methacrylate, isobornyl methacrylate and a mixture of two or more thereof, more preferably selected from the group consisting of methyl methacrylate, n-butyl methacrylate, iso-butyl methacrylate, tert-butyl methacrylate and cyclohexyl methacrylate, more preferably methyl methacrylate.

Preferably the total amount of the one or more of C₁-C₁₀ alkyl ester of methacrylic acid and C₅-C₂₀ cycloalkyl ester of methacrylic acid in the aqueous monomer mixture used in (i.2) is preferably in the range of from 50 to 80 pphm, more preferably in the range of from 55 to 75 pphm, more preferably in the range of from 60 to 70 pphm based on the total amount of monomers used in (i.2). Here, “pphm” refers to parts per hundred monomers, this permits to evaluate the amount of the monomers, namely of the one or more of C₁-C₁₀ alkyl ester of methacrylic acid and C₅-C₂₀ cycloalkyl ester of methacrylic acid in the aqueous monomer mixture used in (i.2), in the monomer mixture (i.2) relative to 100 parts of the monomers forming the monomer mixture (i.2).

More preferably the monomers which do not exhibit a Bronsted acidic group comprised in the aqueous monomer mixture used in (i.2) comprises C₂-C₁₀ alkyl esters of acrylic acid and C₁-C₁₀ alkyl esters of methacrylic acid, more preferably n-butyl acrylate and methyl methacrylate.

Moreover, the ethylenically unsaturated monomers which do not exhibit a Bronsted acidic group comprised in the aqueous mixture prepared according to (i.2) can be—at least with regard to their alkanol part-obtained from biological sources and thus allow for reducing the demand of fossil carbon in the production of the polymer latexes.

In the context of the present invention, the monomers which do not exhibit a Bronsted acidic group comprised in the aqueous monomer mixture used in (i.2) preferably comprises one or more of a monomer having a urea group and a monomer having a keto group, more preferably further comprises a monomer having a urea group and a monomer having a keto group.

Preferably the monomer having a urea group is a ureidoethyl-functional monomer, preferably being selected from the group consisting of ureidoethyl methacrylate, ureidoethyl methacrylamide and the addition product of ureidoethyl amine and allyl glycidyl ether, more preferably being ureidoethyl methacrylate.

Preferably the total amount of the monomer having a urea group in the aqueous monomer mixture used in (i.2) is in the range of from 0.5 to 10 pphm, more preferably in the range of from 1 to 6 pphm, more preferably in the range of from 1.5 to 3 pphm based on the total amount of monomers used in (i.2). Here, “pphm” refers to parts per hundred monomers, this permits to evaluate the amount of the monomers, namely the monomers having a urea group in the aqueous monomer mixture used in (i.2), in the monomer mixture (i.2) relative to 100 parts of the monomers forming the monomer mixture (i.2).

Preferably the monomer having a keto group is selected from the group consisting of diacetoneacrylamide, acetoacetoxyethyl acrylate, acetoacetoxypropyl acrylate, acetoacetoxybutyl acrylate, acetoacetoxyethyl methacrylate, acetoacetoxypropyl methacrylate, acetoacetoxybutyl methacrylate, diacetonemethacrylamide and a mixture of two or more thereof, preferably selected from the group consisting of diacetoneacrylamide and acetoacetoxyethyl methacrylate, more preferably diacetoneacrylamide.

Preferably the total amount of the monomer having a keto group in the aqueous monomer mixture used in (i.2) is in the range of from 1 to 15 pphm, more preferably in the range of from 5 to 13 pphm, more preferably in the range of from 6 to 12 pphm, more preferably in the range of from 8 to 11 pphm based on the total amount of monomers used in (i.2). Here, “pphm” refers to parts per hundred monomers, this permits to evaluate the amount of the monomers, namely the monomers having a keto group in the aqueous monomer mixture used in (i.2), in the monomer mixture (i.2) relative to 100 parts of the monomers forming the monomer mixture (i.2).

More preferably the monomers which do not exhibit a Bronsted acidic group comprised in the aqueous monomer mixture used in (i.2) comprises C₂-C₁₀ alkyl esters of acrylic acid, C₁-C₁₀ alkyl esters of methacrylic acid, monomers having a urea group (more preferably ureidoethyl-functional monomers) and monomers having a keto group, more preferably n-butyl acrylate, methyl methacrylate, ureidoethyl methacrylate and diacetoneacrylamide.

In the aqueous monomer mixture used in (i.2), it is preferred that the weight ratio of the monomers which exhibit a Bronsted acidic group relative to the monomers which do not exhibit a Bronsted acidic group be in the range of from 0.01:1 to 0.18:1, more preferably in the range of from 0.05:1 to 0.15:1, more preferably in the range of from 0.06:1 to 0.14:1, more preferably in the range of from 0.08:1 to 0.12:1.

### Further Components

Preferably the aqueous mixture obtained according to (i.2) further comprises a chain-transfer agent, wherein the chain-transfer agent is more preferably a C₂-C₁₀-alkyl ester of thioglycolic acid, a C₂-C₁₀-alkyl ester of 3-mercaptopropionic acid or a C₆-C₁₄-alkyl mercaptane. Said chain-transfer agent is more preferably selected from the group consisting of 2-ethylhexyl thioglycolate, iso-octyl mercaptopropionate, thioglycolate, n-butyl thioglycolate, n-octyl thioglycolate, 2-propylheptyl thioglycolate, n-dodecyl mercaptane, n-dodecyl mercaptane, tert-dodecyl mercaptane and a mixture of two or more thereof, more preferably selected from the group consisting of 2-ethylhexyl thioglycolate (EHTG), iso-octyl mercaptopropionate (IOMPA), n-dodecyl mercaptane (nDMK) and tert-dodecyl mercaptane (tDMK). More preferably the chain transfer is 2-ethylhexyl thioglycolate (EHTG). Alternatively, the chain-transfer agent is more preferably isooctyl mercaptopropionate (IOMPA).

As to the amount of such agent, it is noted that the skilled person knows how to use such agents and in the particular case of the present invention, it is preferred that the total amount of chain-transfer agent is calculated such that the polymer weight-average molecular weight in the stabilizer dispersion has a Mw in the range of from 2 to 35 kDa, more preferably in the range of from 3 to 25 kDa, more preferably in the range of from 5 to 20 kDa.

Preferably preparing a mixture according to (i.1) is performed in the inert gas atmosphere having a temperature in the range of from 15 to 30° C., more preferably in the range of from 20 to 25° C. In other words, (i.1) is preferably performed in the inert gas atmosphere at room temperature.

Preferably (i) comprises prior to admixing according to (i.2) heating the mixture prepared according to (i.1), obtaining a mixture having a temperature in the range of from 60 to 95° C., more preferably in the range of from 75 to 90° C.

Preferably during admixing and polymerization according to (i.2) and (i.3), the temperature of the mixture is maintained to be in the range of from 60 to 95° C., more preferably in the range of from 75 to 90° C. Thus, it is possible that further heating or cooling be required for maintaining such temperatures.

Preferably the polymerization according to (i.3) is performed at a temperature in the range of from 60 to 95° C., more preferably in the range of from 75 to 90° C.

Preferably, when preparing the stabilizer dispersion according to (i), no compound (such as a base, e.g. ammonia) is further added to neutralize the Bronsted acidic group of the monomers.

Preferably the pH of said stabilizer dispersion prepared according to (i) is in the range of from 0.5 to 3, more preferably in the range of from 0.75 to 2.5.

Preferably the viscosity of said stabilizer dispersion prepared according to (i) is of at most 150 mPas, more preferably in the range of from 2 to 100 mPas, more preferably in the range of from 5 to 50 mPas, more preferably in the range of from 5 to 35 mPas, the viscosity being determined according to Reference Example 1.3.

Preferably the stabilizer dispersion prepared according to (i) has a solid content in the range of from 30 to 55 weight-%, more preferably in the range of from 40 to 50 weight-%, based on the total weight of the stabilizer dispersion prepared according to (i). Without wanting to be bond to any theory, it has been surprisingly found that such high solid content and low viscosity can be obtained with low pH in the dispersion (i).

Preferably the stabilizer dispersion prepared according to (i) has a solid content in the range of from 30 to 55 weight-%, more preferably in the range of from 40 to 50 weight-%, based on the total weight of the stabilizer dispersion prepared according to (i) and exhibits a viscosity of at most 150 mPas, more preferably in the range of from 2 to 100 mPas, more preferably in the range of from 5 to 50 mPas, more preferably in the range of from 5 to 35 mPas, the viscosity being determined according to Reference Example 1.3.

Preferably the stabilizer dispersion prepared according to (i) has a polymer weight-average molecular weight, Mw, in the range of from 2 to 35 kDa, more preferably in the range of from 3 to 25 kDa, more preferably in the range of from 5 to 20 kDa.

### Aqueous Polymer Dispersion Preparation

### Monomers

Preferably the ethylenically unsaturated monomers which do not exhibit a Bronsted acidic group comprised in the aqueous mixture prepared according to (ii.1) comprises one or more of C₁-C₁₂ alkyl esters of acrylic acid, C₁-C₁₂ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, more preferably comprises C₂-C₁₀ alkyl esters of acrylic acid and one or more of C₁-C₁₀ alkyl esters of methacrylic acid and C₅-C₂₀ cycloalkyl esters of (meth)acrylic acid. The cycloalkyl in the aforementioned monomers can preferably be mono-, bi- or tricyclic, wherein 1 or 2 nonadjacent CH₂ moieties of the cycloalkyl may preferably be replaced by oxygen atoms and wherein the cycloalkyl may preferably be unsubstituted or carry 1, 2, 3 or 4 methyl groups, and mono-vinyl aromatic monomers, such as styrene.

More preferably the C₂-C₁₀ alkyl esters of acrylic acid comprised in the aqueous mixture prepared according to (ii.1) are selected from the group consisting of ethyl acrylate, n-butyl acrylate, iso-butyl acrylate, tert-butyl acrylate, n-hexyl acrylate, acrylate, n-octyl acrylate, 2-ethylhexyl acrylate, 2-octyl acrylate, and a mixture of two or more thereof, more preferably selected from the group consisting of n-butyl acrylate, iso-butyl acrylate, tert-butyl acrylate, 2-octyl acrylate, 2-ethylhexyl acrylate and a mixture of two or more thereof, more preferably a mixture of n-butyl acrylate and 2-ethylhexyl acrylate.

Preferably the total amount of C₂-C₁₀ alkyl esters of acrylic acid comprised in the aqueous mixture prepared according to (ii. 1) is in the range of from 55 to 90 pphm, more preferably in the range of from 58 to 80 pphm, more preferably in the range of from 60 to 70 pphm based on the total amount of monomers used in (ii.1). Here, “pphm” refers to parts per hundred monomers, this permits to evaluate the amount of the monomers, namely the C₂-C₁₀ alkyl esters of acrylic acid comprised in the aqueous mixture prepared according to (ii. 1), in the monomer mixture (ii. 1) relative to 100 parts of the monomers forming the monomer mixture (ii.1).

More preferably the one or more of C₁-C₁₀ alkyl esters of methacrylic acid and C₅-C₂₀ cycloalkyl esters of (meth)acrylic acid, are selected from the group consisting of methyl methacrylate, ethyl methacrylate, propyl methacrylate, n-butyl methacrylate, iso-butyl methacrylate, tert-butyl methacrylate, cyclohexyl acrylate, cyclohexyl methacrylate, isobornyl acrylate, isobornyl methacrylate and a mixture of two or more thereof, more preferably selected from the group consisting of methyl methacrylate, n-butyl methacrylate, iso-butyl methacrylate, tert-butyl methacrylate and cyclohexyl methacrylate, more preferably methyl methacrylate.

Preferably the total amount of the one or more of C₁-C₁₀ alkyl esters of methacrylic acid and C₅-C₂₀ cycloalkyl esters of (meth)acrylic acid comprised in the aqueous mixture prepared according to (ii. 1) is in the range of from 10 to 45 pphm, more preferably in the range of from 20 to 42 pphm, more preferably in the range of from 30 to 40 pphm based on the total amount of monomers used in (ii.1). Here, “pphm” refers to parts per hundred monomers, this permits to evaluate the amount of the monomers, namely the one or more of C₁-C₁₀ alkyl esters of methacrylic acid and C₅-C₂₀ cycloalkyl esters of (meth)acrylic acid comprised in the aqueous mixture prepared according to (ii. 1), in the monomer mixture (ii. 1) relative to 100 parts of the monomers forming the monomer mixture (ii.1).

More preferably the ethylenically unsaturated monomers which do not exhibit a Bronsted acidic group comprised in the aqueous mixture prepared according to (ii.1) comprises C₂-C₁₀ alkyl esters of acrylic acid and one or more of C₁-C₁₀ alkyl esters of methacrylic acid and C₅-C₂₀ cycloalkyl esters of (meth)acrylic acid, more preferably n-butyl acrylate, 2-ethylhexyl acrylate and methyl methacrylate.

Moreover, the ethylenically unsaturated monomers which do not exhibit a Bronsted acidic group comprised in the aqueous mixture prepared according to (ii. 1) can be—at least with regard to their alkanol part-obtained from biological sources and thus allow for reducing the demand of fossil carbon in the production of the polymer latexes.

### Base

Preferably the base used in (ii.3), namely for neutralization of the acid groups of the stabilizer dispersion prepared according to (i), is selected from the group consisting of an alkali compound, an alkaline earth compound and primary, secondary or tertiary amine. More preferably, the base used in (ii.3) is selected from the group consisting of ammonium hydroxide, sodium hydroxide (NaOH), sodium carbonate, ammonium bicarbonate, potassium hydroxide (KOH), calcium hydroxide, magnesium oxide, sodium bicarbonate, ethanolamine, dimethylamine, diethylamine, triethylamine, tributylamine, triethanolamine, 2-ethoxyethylamine, 3-ethoxypropylamine, dimethylethanolamine (=DMEA), diethylethanolamine (=DEEA) diisopropanolamine and morpholine, preferably selected from the group consisting of ammonium hydroxide and sodium hydroxide, more preferably is ammonium hydroxide.

Preferably the amount of base introduced according to (ii.3) for neutralization of the acid groups of the stabilizer dispersion prepared according to (i) is calculated such that the final degree of neutralization is of at least 50%, preferably in the range of from 60 to 120%, more preferably in the range of from 70 to 100%.

### Other Components

Preferably the aqueous mixture prepared according to (ii.1) further comprises an emulsifier, wherein the emulsifier more preferably comprises, more preferably consists of, one or more of branched or linear unsaturated alkyl alkoxysulfonates, branched unsaturated alkyl alkoxysulfates, branched unsaturated alkyl alkoxyphosphates and branched unsaturated alkylphosphonates, more preferably branched unsaturated alkyl alkoxysulfates.

For example, the emulsifier can preferably be at least one anionic copolymerizable emulsifier, being more preferably selected from the group consisting of
(1) a compound of formula (I)

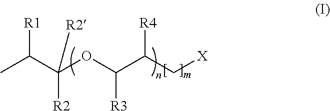

wherein R1 is H, alkyl, cycloalkyl, aralkyl, aryl, or alkoxyaryl, R2, R2′ is H or R2 and R2′ are O, R3 is H or alkyl, R4 is H or OH, X is SO₃⁻, SO₄⁻, HPO₄⁻, PO₄²⁻, or COO⁻, m is 0 or 1, and n is an integer in the range of from 1 to 1000, more preferably in the range of from 1 to 500, more preferably in the range of from 4 to 50;
(2) a compound of formula (II)

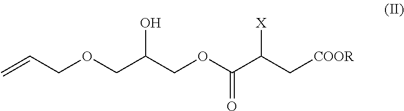

wherein X is SO₃⁻, PO₄²⁻, or SO₄⁻, and R is H, alkyl cycloalkyl, aralkyl, aryl or alkoxyaryl;
(3) a compound of formula (IIIa) or (IIIb)

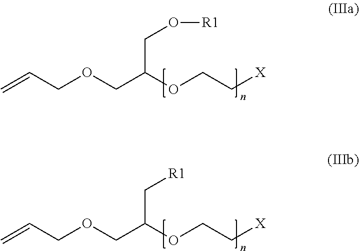

wherein R1 is H, alkyl, cycloalkyl, aralkyl aryl or alkoxyaryl, X is SO₄⁻, SO₃⁻, HPO₄⁻, PO₄²⁻, or COO⁻, n is an integer in the range of from 1 to 1000, more preferably in the range of from 1 to 500, more preferably in the range of from 4 to 50;
(4) a compound of the formula (IV)

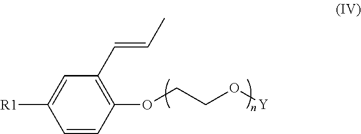

wherein R1 is H, alkyl, cycloalkyl, aralkyl, aryl, or alkoxyaryl, Y is SO₃⁻, PHO₃⁻, or PO₃²⁻, and n is an integer in the range of from 1 to 1000, more preferably in the range of from 1 to 500, more preferably in the range of from 4 to 50;
or mixtures of the compounds of the formulae (I) to (IV).

The anionic copolymerizable emulsifiers may be present in neutralized form. The counterion present for the anionic groups X and/or Y can preferably be a cation selected from the group consisting of Li⁺, Na⁺, K⁺, Ca²⁺, NH₄⁺, and mixtures thereof, more preferably NH₄⁺ or Na⁺.

Preferably Tg(S)−Tg(E)≥50° C., Tg(S) being the theoretical glass transition temperature (Tg) of the polymer which would be obtained from polymerization of the monomers of the aqueous monomer mixture used in (i.2) and Tg(E) being the theoretical glass transition temperature (Tg) of the polymer which would be obtained from polymerization of the monomers of the aqueous mixture prepared according to (ii.1), wherein said theoretical glass transition temperatures Tg(E) and Tg(S) are determined according to the Fox equation.

Preferably Tg(E) is of at most 10° C., more preferably in the range of from −80 to 10° C., more preferably in the range of from −60 to 0° C., Tg(E) being the theoretical glass transition temperature (Tg) of the polymer which would be obtained from polymerization of the monomers of the aqueous mixture prepared according to (ii.1), wherein said theoretical glass transition temperatures Tg(E) is determined according to the Fox equation.

In the context of the present invention, prior to (ii.2), the process preferably comprises introducing, into the polymerization vessel, water and one or more of a surfactant and an initiator, more preferably water, a surfactant and an initiator.

Preferably introducing said aqueous mixture as a first feed according to (ii.2) is performed continuously into the polymerization vessel.

Preferably the first feed is introduced into the polymerization vessel according to (ii.2) at a constant feed rate. More preferably the first feed is introduced continuously and at a constant feed rate.

Preferably, as an alternative, the first feed is introduced sequentially into the polymerization vessel according to (ii.2) at different feed rates, F1-Fx, with x=2 or more, in g/h, wherein F1 (g/h)<Fx (g/h), for durations D1-Dx, respectively, wherein from 50 to 95 weight-% of the first feed are introduced at the highest feed rate Fx.

Preferably x=2, the first feed is introduced sequentially into the polymerization vessel according to (ii.2) at two different feed rates, F1 and F2, in g/h, wherein F1 (g/h)<F2 (g/h), wherein the first feed is introduced at the feed rate F1 for a duration D1 in the range of from 20 to 100 minutes, more preferably in the range of from 50 to 90 minutes, and subsequently at the feed rate F2 for a duration D2 in the range of from 90 to 200 minutes, more preferably in the range of from 100 to 150 minutes.

Preferably, as a further alternative, the first feed is introduced into the polymerization vessel according to (ii.2) at different feed rates, F1-Fx, with x=3 or more, in g/h, wherein one of the feed rates F1-Fx, which is not F1 or Fx, is 0 g/h for a duration in the range of from 5 to 30 minutes, preferably in the range of from 10 to 20 minutes. While the feed rate of the first feed is 0 g/h for the duration disclosed above, it is preferred that the introduction of the second feed into the vessel not be interrupted or be started.

Preferably introducing said aqueous mixture as a first feed into a polymerization vessel according to (ii.2) is performed at a time T(1) and introducing the stabilizer dispersion obtained according to (i) as a second feed according to (ii.3) is performed at a time T(2), wherein T(2)>T(1)+10 minutes, more preferably T(1)+10 minutes≤T(2)≤T(1)+120 minutes, more preferably T(1)+15 minutes≤T(2)≤T(1)+90 minutes.

Preferably introducing the stabilizer dispersion obtained according to (i) as a second feed according to (ii.3) is performed for a period in the range of from 90 to 250 minutes, more preferably in the range of from 100 to 200 minutes.

Preferably the second feed is introduced into the polymerization vessel continuously according to (ii.3) at a constant feed rate.

Preferably the second feed is introduced into the polymerization vessel continuously according to (ii.3) at different feed rates, F′1-F′y, with y=2 or more, in g/h, wherein F′1 (g/h)<F′2 (g/h), wherein from 20 to 95 weight-% of the second feed is introduced at the feed rate F′2.

Preferably the second feed is introduced into the polymerization vessel continuously according to (ii.3) at two different feed rates F′1 and F′2, wherein F′1 (g/h)<F′2 (g/h), wherein from 70 to 95 weight-% of the second feed is introduced at the feed rate F′2. More preferably the second feed is introduced at a feed rate F′1 for a period P′1 and the second feed is introduced at a feed rate F′2 for a period P′2, wherein P′1 (minutes)<P′2 (minutes).

Preferably y=3, the second feed is introduced into the polymerization vessel continuously according to (ii.3) at three different feed rates F′1, F′2 and F′3, wherein F′1 (g/h)<F′2 (g/h)>F′3 (g/h), with F′1=F′3 or F′1<F′3, wherein from 23 to 60 weight-% of the second feed is introduced at the feed rate F′2. More preferably the second feed is introduced at a feed rate F′1 for a period P′1, the second feed is introduced at a feed rate F′2 for a period P′2, the second feed is introduced at a feed rate F′3 for a period P′3, wherein P′2 (minutes)<P′1 (minutes)<P′3 (minutes).

Preferably the base is introduced according to (ii.3) into the polymerization vessel prior to the second feed, being the stabilizer dispersion obtained according to (i). Therefore, the present invention preferably relates to a process for preparing an aqueous polymer dispersion having a polymer content of at least 50 weight-% based on the total weight of the aqueous polymer dispersion, the process comprising
(i) preparing a stabilizer dispersion, comprising
   subjecting ethylenically unsaturated monomers comprising monomers which exhibit a Bronsted acidic group and further comprising monomers which do not exhibit a Bronsted acidic group, to co-polymerization in water, obtaining said stabilizer dispersion having a pH in the range of from 0 to 5;
(ii) preparing said aqueous polymer dispersion, comprising
   (ii. 1) preparing an aqueous mixture comprising water and ethylenically unsaturated monomers which do not exhibit a Bronsted acidic group;
   (ii.2) introducing said aqueous mixture as a first feed into a polymerization vessel and subjecting the monomers comprised in said aqueous mixture to co-polymerization in said polymerization vessel;
   (ii.3) introducing the stabilizer dispersion obtained according to (i) as a second feed and a base into the polymerization vessel comprising at least a portion of said aqueous mixture, obtaining said aqueous polymer dispersion, wherein the base is introduced into the polymerization vessel prior to said second feed;
wherein the polymer particles of the aqueous polymer dispersion obtained according to (ii) exhibit a polymodal particle size distribution;
wherein at least 95 weight-% of the polymers comprised in the aqueous polymer dispersion are based on the monomers employed according to (i) and (ii).

In the context of the present invention, it is preferred that the one or more polymers comprised in the stabilizer dispersion obtained according to (i) is introduced into the polymerization vessel according to (ii.3) at an amount in the range of from 15 to 45 weight-%, more preferably from 18 to 40 weight-%, more preferably from 20 to 35 weight-%, based on the weight of the one or more polymers comprised in the stabilizer dispersion plus the weight of the monomers comprised in the aqueous monomer mixture used in (ii.2).

Preferably the process of the present invention consists of (i) and (ii).

The present invention further relates to an aqueous polymer dispersion having a polymer content of at least 50 weight-% based on the total weight of the aqueous polymer dispersion obtainable or obtained by a process according to the present invention, wherein the polymer particles of the aqueous polymer dispersion exhibit a polymodal particle size distribution.

Preferably the aqueous polymer dispersion has a polymer content in the range of from 50 to 70 weight-%, more preferably in the range of from 51 to 60 weight-%, more preferably in the range of from 52 to 55 weight-% based on the total weight of the aqueous polymer dispersion.

Preferably the aqueous polymer dispersion has a bimodal particle size distribution.

Preferably the aqueous polymer dispersion has a bimodal particle size distribution such that X weight-% of the particles of the dispersion have a diameter in the range of from 10 to 100 nm, more preferably from 20 to 80 nm, more preferably from 30 to 75 nm, and Y weight-% of the particles of the dispersion have a diameter in the range of 175 to 400 nm, more preferably in the range of from 185 to 300 nm, more preferably in the range of from 200 to 260 nm, wherein Y=100−X.

Preferably X is in the range of from 10 to 60, more preferably in the range of from 15 to 50, more preferably in the range of from 20 to 40.

Preferably X is in the range of from 25 to 38, more preferably from 30 to 35, wherein more preferably the X weight-% of the particles of the dispersion have a diameter in the range of from 30 to 40 nm and more preferably the Y weight-% of the particles of the dispersion have a diameter in the range of 220 to 260 nm.

For example, it is preferred that X is about ⅓ Y.

Preferably the aqueous polymer dispersion has a viscosity in the range of from 150 to 7000 mPas, more preferably in the range of from 200 to 6300 mPas, more preferably in the range of from 200 to 1000 mPas; or more preferably in the range of from 2000 to 6300 mPas.

The present invention further relates to a use of an aqueous polymer dispersion according to the present invention as binder for coatings, preferably architectural and industrial coatings.

The present invention further relates to a coating composition comprising an aqueous polymer dispersion according to the present invention and a pigment.

As to the amount of binder (=aqueous polymer dispersion of the present invention) in the coating, it is noted that the skilled person knows which amount using depending on the use and the application of the coating. Examples of amount are illustrated in the examples of the present invention. For example, the coating composition can preferably comprise the aqueous polymer dispersion according to the present invention in an amount in the range of from 15 to 80 weight-% based on the weight of the coating composition.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 2 to 4”, every embodiment in this range is meant to be explicitly disclosed for the skilled person, i.e. the wording of this term is to be understood by the skilled person as being synonymous to “The process of any one of embodiments 2, 3, and 4”. Further, it is explicitly noted that the following set of embodiments represents a suitably structured part of the general description directed to preferred aspects of the present invention, and, thus, suitably supports, but does not represent the claims of the present invention.

1. A process for preparing an aqueous polymer dispersion having a polymer content of at least 50 weight-% based on the total weight of the aqueous polymer dispersion, the process comprising
(i) preparing a stabilizer dispersion, comprising
   subjecting ethylenically unsaturated monomers comprising monomers which exhibit a Bronsted acidic group and further comprising monomers which do not exhibit a Bronsted acidic group, to co-polymerization in water, obtaining said stabilizer dispersion having a pH in the range of from 0 to 5;
(ii) preparing said aqueous polymer dispersion, comprising
   (ii.1) preparing an aqueous mixture comprising water and ethylenically unsaturated monomers which do not exhibit a Bronsted acidic group;
   (ii.2) introducing said aqueous mixture as a first feed into a polymerization vessel and subjecting the monomers comprised in said aqueous mixture to copolymerization in said polymerization vessel;
   (ii.3) introducing the stabilizer dispersion obtained according to (i) as a second feed and a base into the polymerization vessel comprising at least a portion of said aqueous mixture, obtaining said aqueous polymer dispersion;
wherein the polymer particles of the aqueous polymer dispersion obtained according to (ii) exhibit a polymodal particle size distribution;
wherein at least 95 weight-% of the polymers comprised in the aqueous polymer dispersion are based on the monomers employed according to (i) and (ii).

2. The process of embodiment 1, wherein (i) comprises
(i.1) preparing a mixture of water and a surfactant under an inert gas atmosphere;
(i.2) admixing the mixture prepared according to (i.1) with an aqueous monomer mixture comprising water and ethylenically unsaturated monomers comprising monomers which exhibit a Bronsted acidic group and further comprising monomers which do not exhibit a Bronsted acidic group;
(i.3) subjecting the aqueous mixture obtained according to (i.2) to co-polymerization.

3. The process of embodiment 2, wherein (i) consists of (i.1) and (i.2) and (i.3).

4. The process of embodiment 2 or 3, wherein the surfactant used in (i.1) is an emulsifier comprising, preferably consisting of, one or more of branched or linear unsaturated alkyl alkoxysulfonates, branched unsaturated alkyl alkoxysulfates, branched unsaturated alkyl alkoxyphosphates and branched unsaturated alkylphosphonates, more preferably branched unsaturated alkyl alkoxysulfates.

5. The process of any one of embodiments 2 to 4, wherein admixing according to (i.2) is performed at a temperature in the range of from 15 to 35° C., preferably in the range of from 18 to 30° C., more preferably in the range of from 20 to 25° C.

6. The process of any one of embodiments 2 to 5, wherein Tg(S) is of at least 50° C., preferably in the range of from 50 to 150° C., more preferably in the range of from 70 to 125° C., more preferably in the range of from 80 to 100° C., Tg(S) being the theoretical glass transition temperature (Tg) of the polymer which would be obtained from polymerization of the monomers of the aqueous monomer mixture used in (i.2), wherein said theoretical glass transition temperatures Tg(S) is determined according to the Fox equation.

7. The process of any one of embodiments 2 to 6, wherein the monomers which exhibit a Bronsted acidic group comprised in the aqueous monomer mixture used in (i.2) are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof, preferably monoethylenically unsaturated monocarboxylic acids having 3 to 6 carbon atoms.

8. The process of embodiment 7, wherein the monoethylenically unsaturated monocarboxylic acids having 3 to 6 carbon atoms are one or more of methacrylic acids, acrylic acids, crotonic acids, 2-ethylpropenoic acids, 2-propylpropenoic acids, 2-acryloxyacetic acids and 2-methacyloxyacetic acids; and/or wherein the monoethylenically unsaturated dicarboxylic acids having 4 to 6 carbon atoms are one or more of itaconic acids, maleic acids and fumaric acids.

9. The process of any one of embodiments 2 to 8, wherein the total amount of monomers which exhibit a Bronsted acidic group comprised in the aqueous mixture obtained according to (i.2) is in the range of from 0.5 to 10 weight-%, preferably in the range of from 1 to 8 weight-%, more preferably in the range of from 3 to 7 weight-%, more preferably in the range of from 4 to 6 weight-%, based on the total weight of the aqueous mixture obtained according to (i.2).

10. The process of any one of embodiments 2 to 9, wherein the total amount of monomers which exhibit a Bronsted acidic group comprised in the aqueous monomer mixture used in (i.2) is in the range of from 1 to 15 pphm (parts per hundred monomers), preferably in the range of from 5 to 13 pphm, more preferably in the range of from 6 to 12 pphm, more preferably in the range of from 8 to 11 pphm based on the total amount of monomers used in (i.2).

11. The process of any one of embodiments 2 to 10, wherein the monomers which do not exhibit a Bronsted acidic group comprised in the aqueous monomer mixture used in (i.2) comprises one or more of esters of acrylic acid and esters of methacrylic acid, preferably esters of acrylic acid and esters of methacrylic acid;
wherein the esters of acrylic acid are one or more of C₁-C₁₂ alkyl esters of acrylic acid, C₅-C₂₀ cycloalkyl esters of acrylic acid and C₅-C₂₀ cycloalkylmethyl esters of acrylic acid, preferably one or more of C₁-C₁₂ alkyl esters of acrylic acid and C₅-C₂₀ cycloalkyl esters of acrylic acid, more preferably one or more of C₂-C₁₀ alkyl esters of acrylic acid and C₅-C₂₀ cycloalkyl esters of acrylic acid;
wherein the esters of methacrylic acid are one or more of C₁-C₁₂ alkyl esters of methacrylic acid, C₅-C₂₀ cycloalkyl esters of methacrylic acid and C₅-C₂₀ cycloalkylmethyl esters of methacrylic acid, preferably one or more of C₁-C₁₂ alkyl esters of methacrylic acid and C₅-C₂₀ cycloalkyl esters of methacrylic acid, more preferably one or more of C₁-C₁₀ alkyl esters of methacrylic acid and C₅-C₂₀ cycloalkyl esters of methacrylic acid.

12. The process of embodiment 11, wherein the monomers which do not exhibit a Bronsted acidic group comprised in the aqueous monomer mixture used in (i.2) comprises one or more of C₂-C₁₀ alkyl ester of acrylic acid and C₅-C₂₀ cycloalkyl ester of acrylic acid, wherein said monomers are selected from the group consisting of ethyl acrylate, n-butyl acrylate, iso-butyl acrylate, tert-butyl acrylate, n-hexyl acrylate, n-octyl acrylate, 2-ethylhexyl acrylate, 2-octyl acrylate, isobornyl acrylate and a mixture of two or more thereof, preferably selected from the group consisting of n-butyl acrylate, iso-butyl acrylate, tert-butyl acrylate, n-octyl acrylate and 2-ethylhexyl acrylate, more preferably is n-butyl acrylate; wherein the total amount of the one or more of C₂-C₁₀ alkyl ester of acrylic acid and C₅-C₂₀ cycloalkyl ester of acrylic acid in the aqueous monomer mixture used in (i.2) is preferably in the range of from 1 to 15 pphm, more preferably in the range of from 5 to 13 pphm, more preferably in the range of from 6 to 12 pphm, more preferably in the range of from 8 to 11 pphm based on the total amount of monomers used in (i.2).

13. The process of embodiment 11 or 12, wherein the monomers which do not exhibit a Bronsted acidic group comprised in the aqueous monomer mixture used in (i.2) comprises one or more of C₁-C₁₀ alkyl ester of methacrylic acid and C₅-C₂₀ cycloalkyl ester of methacrylic acid, wherein the monomers are selected from the group consisting of methyl methacrylate, ethyl methacrylate, propyl methacrylate, n-butyl methacrylate, iso-butyl methacrylate, tert-butyl methacrylate, cyclohexyl methacrylate, isobornyl methacrylate and a mixture of two or more thereof, preferably selected from the group consisting of methyl methacrylate, n-butyl methacrylate, iso-butyl methacrylate, tert-butyl methacrylate and cyclohexyl methacrylate, more preferably methyl methacrylate;
wherein the total amount of the one or more of C₁-C₁₀ alkyl ester of methacrylic acid and C₅-C₂₀ cycloalkyl ester of methacrylic acid in the aqueous monomer mixture used in (i.2) is preferably in the range of from 50 to 80 pphm, more preferably in the range of from 55 to 75 pphm, more preferably in the range of from 60 to 70 pphm based on the total amount of monomers used in (i.2).

14. The process of any one of embodiments 2 to 13, wherein the monomers which do not exhibit a Bronsted acidic group comprised in the aqueous monomer mixture used in (i.2) comprises one or more of a monomer having a urea group and a monomer having a keto group, preferably further comprises a monomer having a urea group and a monomer having a keto group.

15. The process of embodiment 14, wherein the monomer having a urea group is a ureidoethyl-functional monomer, preferably being selected from the group consisting of ureidoethyl methacrylate, ureidoethyl methacrylamide and the addition product of ureidoethyl amine and allyl glycidyl ether, more preferably being ureidoethyl methacrylate; wherein the total amount of the monomer having a urea group in the aqueous monomer mixture used in (i.2) is preferably in the range of from 0.5 to 10 pphm, more preferably in the range of from 1 to 6 pphm, more preferably in the range of from 1.5 to 3 pphm based on the total amount of monomers used in (i.2).

16. The process of embodiment 14 or 15, wherein the monomer having a keto group is selected from the group consisting of diacetoneacrylamide, acetoacetoxyethyl acrylate, acetoacetoxypropyl acrylate, acetoacetoxybutyl acrylate, acetoacetoxyethyl methacrylate, acetoacetoxypropyl methacrylate, acetoacetoxybutyl methacrylate, diacetonemethacrylamide and a mixture of two or more thereof, preferably selected from the group consisting of diacetoneacrylamide and acetoacetoxyethyl methacrylate, more preferably diacetoneacrylamide;
wherein the total amount of the monomer having a keto group in the aqueous monomer mixture used in (i.2) is preferably in the range of from 1 to 15 pphm, more preferably in the range of from 5 to 13 pphm, more preferably in the range of from 6 to 12 pphm, more preferably in the range of from 8 to 11 pphm based on the total amount of monomers used in (i.2).

17. The process of any one of embodiments 2 to 17, wherein in the aqueous monomer mixture used in (i.2) the weight ratio of the monomers which exhibit a Bronsted acidic group to the monomers which do not exhibit a Bronsted acidic group is in the range of from 0.01:1 to 0.18:1, preferably in the range of from 0.05:1 to 0.15:1, more preferably in the range of from 0.06:1 to 0.14:1, more preferably in the range of from 0.08:1 to 0.12:1.

18. The process of any one of embodiments 2 to 17, wherein the aqueous mixture obtained according to (i.2) further comprises a chain-transfer agent, wherein the chain-transfer agent is preferably a C₂-C₁₀-alkyl ester of thioglycolic acid, a C₂-C₁₀-alkyl ester of 3-mercaptopropionic acid or a C₆-C₁₄-alkyl mercaptane, being more preferably selected from the group consisting of 2-ethylhexyl thioglycolate, iso-octyl mercaptopropionate, thioglycolate, n-butyl thioglycolate, n-octyl thioglycolate, 2-propylheptyl thioglycolate, n-dodecyl mercaptane, n-dodecyl mercaptane, tert-dodecyl mercaptane and a mixture of two or more thereof, more preferably selected from the group consisting of 2-ethylhexyl thioglycolate (EHTG), iso-octyl mercaptopropionate (IOMPA), n-dodecyl mercaptane (nDMK) and tert-dodecyl mercaptane (tDMK),
more preferably the chain transfer is 2-ethylhexyl thioglycolate (EHTG) or more preferably iso-octyl mercaptopropionate (IOMPA).

19. The process of any one of embodiments 2 to 18, wherein preparing a mixture according to (i. 1) is performed in the inert gas atmosphere having a temperature in the range of from 15 to 30° C., preferably in the range of from 20 to 25° C.

20. The process of any one of embodiments 2 to 19, wherein (i) comprises prior to admixing according to (i.2) heating the mixture prepared according to (i. 1), obtaining a mixture having a temperature in the range of from 60 to 90° C., preferably in the range of from 70 to 85° C.

21. The process of any one of embodiments 2 to 20, wherein the polymerization according to (i.3) is performed at a temperature in the range of from 60 to 90° C., preferably in the range of from 70 to 85° C.

22. The process of any one of embodiments 1 to 21, wherein, when preparing the stabilizer dispersion according to (i), no compound is further added to neutralize the Bronsted acidic group of the monomers.

23. The process of any one of embodiments 1 to 22, wherein the pH of said stabilizer dispersion prepared according to (i) is in the range of from 0.5 to 3, preferably in the range of from 0.75 to 2.5.

24. The process of any one of embodiments 1 to 23, wherein the viscosity of said stabilizer dispersion prepared according to (i) is of at most 150 mPas, preferably in the range of from 2 to 100 mPas, more preferably in the range of from 5 to 50 mPas, more preferably in the range of from 5 to 35 mPas, the viscosity being determined according to Reference Example 1.3.

25. The process of any one of embodiments 1 to 24, wherein the stabilizer dispersion prepared according to (i) has a solid content in the range of from 30 to 55 weight-%, preferably in the range of from 40 to 50 weight-%, based on the total weight of the stabilizer dispersion prepared according to (i).

26. The process of any one of embodiments 1 to 25, wherein the stabilizer dispersion prepared according to (i) has a polymer molecular weight, Mw, in the range of from 2 to 35 kDa, preferably in the range of from 3 to 25 kDa, more preferably in the range of from 5 to 20 kDa.

27. The process of any one of embodiments 1 to 26, wherein the ethylenically unsaturated monomers which do not exhibit a Bronsted acidic group comprised in the aqueous mixture prepared according to (ii.1) comprises one or more of C₁-C₁₂ alkyl esters of acrylic acid, C₁-C₁₂ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, preferably comprises C₂-C₁₀ alkyl esters of acrylic acid and one or more of C₁-C₁₀ alkyl esters of methacrylic acid and C₅-C₂₀ cycloalkyl esters of (meth)acrylic acid.

28. The process of embodiment 27, wherein the C₂-C₁₀ alkyl esters of acrylic acid comprised in the aqueous mixture prepared according to (ii. 1) are selected from the group consisting of ethyl acrylate, n-butyl acrylate, iso-butyl acrylate, tert-butyl acrylate, n-hexyl acrylate, acrylate, n-octyl acrylate, 2-ethylhexyl acrylate, 2-octyl acrylate, and a mixture of two or more thereof, preferably selected from the group consisting of n-butyl acrylate, iso-butyl acrylate, tert-butyl acrylate, 2-octyl acrylate, 2-ethylhexyl acrylate and a mixture of two or more thereof, more preferably a mixture of n-butyl acrylate and 2-ethylhexyl acrylate; wherein the total amount of C₂-C₁₀ alkyl esters of acrylic acid comprised in the aqueous mixture prepared according to (ii.1) is preferably in the range of from 55 to 90 pphm, more preferably in the range of from 58 to 80 pphm, more preferably in the range of from 60 to 70 pphm based on the total amount of monomers used in (ii.1).

29. The process of embodiment 27 or 28, wherein the ethylenically unsaturated monomers which do not exhibit a Bronsted acidic group comprised in the aqueous mixture prepared according to (ii.1) comprises one or more of C₁-C₁₀ alkyl esters of methacrylic acid and C₅-C₂₀ cycloalkyl esters of (meth)acrylic acid, being selected from the group consisting of methyl methacrylate, ethyl methacrylate, propyl methacrylate, n-butyl methacrylate, iso-butyl methacrylate, tert-butyl methacrylate, cyclohexyl acrylate, cyclohexyl methacrylate, isobornyl acrylate, isobornyl methacrylate and a mixture of two or more thereof, preferably selected from the group consisting of methyl methacrylate, n-butyl methacrylate, iso-butyl methacrylate, tert-butyl methacrylate and cyclohexyl methacrylate, more preferably methyl methacrylate;
wherein the total amount of the one or more of C₁-C₁₀ alkyl esters of methacrylic acid and C₅-C₂₀ cycloalkyl esters of (meth)acrylic acid comprised in the aqueous mixture prepared according to (ii. 1) is preferably in the range of from 10 to 45 pphm, more preferably in the range of from 20 to 42 pphm, more preferably in the range of from 30 to 40 pphm based on the total amount of monomers used in (ii.1).

30. The process of any one of embodiments 1 to 29, wherein the aqueous mixture prepared according to (ii. 1) further comprises an emulsifier, wherein the emulsifier preferably comprises, more preferably consists of, one or more of branched or linear unsaturated alkyl alkoxysulfonates, branched unsaturated alkyl alkoxysulfates, branched unsaturated alkyl alkoxyphosphates and branched unsaturated alkylphosphonates, more preferably branched unsaturated alkyl alkoxysulfates.

31. The process of any one of embodiments 1 to 30, as far as embodiment 31 depends on embodiment 2, wherein Tg(S)−Tg(E)≥50° C., Tg(S) being the theoretical glass transition temperature (Tg) of the polymer which would be obtained from polymerization of the monomers of the aqueous monomer mixture used in (i.2) and Tg(E) being the theoretical glass transition temperature (Tg) of the polymer which would be obtained from polymerization of the monomers of the aqueous mixture prepared according to (ii. 1), wherein said theoretical glass transition temperatures Tg(E) and Tg(S) are determined according to the Fox equation;
wherein Tg(E) is preferably of at most 10° C., more preferably in the range of from −80 to 10° C., more preferably in the range of from −60 to 0° C., Tg(E) being the theoretical glass transition temperature (Tg) of the polymer which would be obtained from polymerization of the monomers of the aqueous mixture prepared according to (ii.1), wherein said theoretical glass transition temperatures Tg(E) is determined according to the Fox equation.

32. The process of any one of embodiments 1 to 31, wherein prior to (ii.2), the process comprises introducing, into the polymerization vessel, water and one or more of a surfactant and an initiator, preferably water, a surfactant and an initiator.

33. The process of any one of embodiments 1 to 32, wherein introducing said aqueous mixture as a first feed according to (ii.2) is performed continuously into the polymerization vessel.

34. The process of embodiment 33, wherein the first feed is introduced into the polymerization vessel according to (ii.2) at a constant feed rate; or
wherein the first feed is introduced sequentially into the polymerization vessel according to (ii.2) at different feed rates, F1-Fx, with x=2 or more, in g/h, wherein F1 (g/h)<Fx (g/h), for durations D1-Dx, respectively, wherein from 50 to 95 weight-% of the first feed are introduced at the highest feed rate Fx;
wherein, preferably x=2, the first feed is introduced sequentially into the polymerization vessel according to (ii.2) at two different feed rates, F1 and F2, in g/h, wherein F1 (g/h)<F2 (g/h), wherein the first feed is introduced at the feed rate F1 for a duration D1 in the range of from 20 to 100 minutes, more preferably in the range of from 50 to 90 minutes, and subsequently at the feed rate F2 for a duration D2 in the range of from 90 to 200 minutes, more preferably in the range of from 100 to 150 minutes.

35. The process of any one of embodiments 1 to 31, wherein the first feed is introduced into the polymerization vessel according to (ii.2) at different feed rates, F1-Fx, with x=3 or more, in g/h, wherein one of the feed rates F1-Fx, which is not F1 or Fx, is 0 g/h for a duration in the range of from 5 to 30 minutes, preferably in the range of from 10 to 20 minutes.

36. The process of any one of embodiments 1 to 35, wherein introducing said aqueous mixture as a first feed into a polymerization vessel according to (ii.2) is performed at a time T(1) and introducing the stabilizer dispersion obtained according to (i) as a second feed according to (ii.3) is performed at a time T(2), wherein T(2)>T(1)+10 minutes, preferably T(1)+10 minutes≤T(2)≤T(1)+120 minutes, more preferably T(1)+15 minutes≤T(2)≤ T(1)+90 minutes.

37. The process of any one of embodiments 1 to 36, wherein introducing the stabilizer dispersion obtained according to (i) as a second feed according to (ii.3) is performed for a period in the range of from 90 to 250 minutes, preferably in the range of from 100 to 200 minutes.

37. The process of any one of embodiments 1 to 37, wherein the second feed is introduced into the polymerization vessel continuously according to (ii.3) at a constant feed rate.

38. The process of any one of embodiments 1 to 37, wherein the second feed is introduced into the polymerization vessel continuously according to (ii.3) at different feed rates, F′1-F′y, with y=2 or more, in g/h, wherein F′1 (g/h)<F′2 (g/h), wherein from 20 to 95 weight-% of the second feed is introduced at the feed rate F′2.

39. The process of embodiment 38, wherein y=2, wherein the second feed is introduced into the polymerization vessel continuously according to (ii.3) at two different feed rates F′1 and F′2, wherein F′1 (g/h)<F′2 (g/h), wherein from 70 to 95 weight-% of the second feed is introduced at the feed rate F′2;
wherein preferably the second feed is introduced at a feed rate F′1 for a period P′1 and the second feed is introduced at a feed rate F′2 for a period P′2, wherein P′1 (minutes)<P′2 (minutes).

40. The process of embodiment 38, wherein y=3, wherein the second feed is introduced into the polymerization vessel continuously according to (ii.3) at three different feed rates F′1, F′2 and F′3, wherein F′1 (g/h)<F′2 (g/h)>F′3 (g/h), with F′1=F′3 or F′1<F′3, wherein from 23 to 60 weight-% of the second feed is introduced at the feed rate F′2;
wherein preferably the second feed is introduced at a feed rate F′1 for a period P′1, the second feed is introduced at a feed rate F′2 for a period P′2, the second feed is introduced at a feed rate F′3 for a period P′3, wherein P′2 (minutes)<P′1 (minutes)<P′3 (minutes).

41. The process of any one of embodiments 1 to 40, wherein the base is introduced according to (ii.3) into the polymerization vessel prior to the second feed being the stabilizer dispersion obtained according to (i), wherein the base is preferably selected from the group consisting of ammonium hydroxide, sodium hydroxide, sodium carbonate, ammonium bicarbonate, potassium hydroxide, calcium hydroxide, sodium bicarbonate, more preferably selected from the group consisting of ammonium hydroxide and sodium hydroxide, more preferably is ammonium hydroxide.

42. The process of any one of embodiments 1 to 41, wherein the one or more polymers comprised in the stabilizer dispersion obtained according to (i) is introduced into the polymerization vessel according to (ii.3) at an amount in the range of from 15 to 45 weight-%, preferably from 18 to 40 weight-%, more preferably from 20 to 35 weight-%, based on the weight of the one or more polymers comprised in the stabilizer dispersion plus the weight of the monomers comprised in the aqueous monomer mixture used in (ii.2).

43. An aqueous polymer dispersion having a polymer content of at least 50 weight-% based on the total weight of the aqueous polymer dispersion obtainable or obtained by a process according to any one of embodiments 1 to 42, wherein the polymer particles of the aqueous polymer dispersion exhibit a polymodal particle size distribution.

44. The aqueous polymer dispersion of embodiment 43, having a polymer content in the range of from 50 to 70 weight-%, preferably in the range of from 51 to 60 weight-%, more preferably in the range of from 52 to 55 weight-% based on the total weight of the aqueous polymer dispersion.

45. The aqueous polymer dispersion of embodiment 43 or 44, having a bimodal particle size distribution.

46. The aqueous polymer dispersion of embodiment 45, having a bimodal particle size distribution such that X weight-% of the particles of the dispersion have a diameter in the range of from 10 to 100 nm, preferably from 20 to 80 nm, more preferably from 30 to 75 nm, and Y weight-% of the particles of the dispersion have a diameter in the range of 175 to 400 nm, preferably in the range of from 185 to 300 nm, more preferably in the range of from 200 to 260 nm, wherein Y=100-X.

47. The aqueous polymer dispersion of embodiment 46, wherein X is in the range of from 10 to 60, preferably in the range of from 15 to 50, more preferably in the range of from 20 to 40.

48. The aqueous polymer dispersion of embodiment 46 or 47, wherein X is in the range of from 30 to 35, wherein preferably the X weight-% of the particles of the dispersion have a diameter in the range of from 30 to 40 nm and preferably the Y weight-% of the particles of the dispersion have a diameter in the range of 220 to 260 nm 49. The aqueous polymer dispersion of any one of embodiments 43 to 48, having a viscosity in the range of from 150 to 7000 mPas, preferably in the range of from 200 to 6300 mPas, more preferably in the range of from 200 to 1000 mPas or more preferably in the range of from 2000 to 6300 mPas.

50. Use of an aqueous polymer dispersion according to any one of embodiments 43 to 49 as binder for coatings, preferably architectural and industrial coatings.

51. A coating composition comprising an aqueous polymer dispersion according to any one of embodiments 43 to 49 and a pigment.

In the context of the present invention, it is noted that the “stabilizer dispersion” could also be called a “protective colloid”.

In the context of the present invention, the particle size distribution is measured at room temperature as well known in the art, namely at a temperature ranging from 18 to 30° C.

In the context of the present invention, the solid content disclosed herein is determined as described in Reference Example 1.1. Further, in the context of the present invention, the particle size distribution/HDC disclosed herein are determined as described in Reference Example 1.2.

Further, in the context of the present invention, the viscosity disclosed herein is determined as described in Reference Example 1.3. Furthermore, in the context of the present invention, the pH disclosed herein is determined as described in Reference Example 1.4.

In the context of the present invention, it is noted that the glass transition temperature of the polymer dispersion particles is governed by the monomer composition and thus by composition of the monomers to be polymerized. Therefore, by choosing proper amounts of monomers in the aqueous monomer mixture used in (i.2) and the aqueous mixture prepared according to (ii. 1), the glass transition temperature of the polymer to be obtained can be adjusted. According to T. G. Fox, Bulletin of the American Physical Society 1, page 123 (1956 [Ser. II]) and according to Ullmann's Encyclopedia of Industrial Chemistry (vol. 19, page 18, 4^{th} Edition, Verlag Chemie, Weinheim, 1980), the following is a good approximation of the glass transition temperature of no more than lightly cross-linked copolymers:

$$1 / Tg = {x}_{1} / {Tg}_{1} + {x}_{2} / {Tg}_{2} + … {x}_{n} / {Tg}_{n} ,$$

where x₁, x₂, . . . xₙ are the mass fractions of the monomers 1, 2, . . . n and Tg₁, Tg₂, . . . . Tgₙ are the glass transition temperatures in degrees Kelvin of the polymers synthesized from only one of the monomers 1, 2, . . . n at a time. The Tg values for the homopolymers of most monomers are known and listed, for example, in Ullmann's Encyclopedia of Industrial Chemistry (vol. A21, page 169, 5th Edition, Verlag Chemie, Weinheim, 1992); further sources of glass transition temperatures of homopolymers are, for example, J. Brandrup, E. H. Immergut, Polymer Handbook, 1st Edition—J. Wiley, New York 1966, 2^{nd} Edition—J. Wiley, New York 1975, and 3^{rd} Edition—J. Wiley, New York 1989.

For the sake of clarity, the following table displays the theoretical glass transition temperatures of homopolymers that have been used for the calculation of this invention's copolymers employing the Fox equation:

| Monomer | Tg (homopolymer) | | Source |
|---|---|---|---|
| ethyl acrylate | −8° | C. | Tsavalas¹ |
| n-butyl acrylate | −40° | C. | Tsavalas |
| 2-ethylhexyl acrylate | −60° | C. | Tsavalas |
| n-butyl methacrylate | +35° | C. | Tsavalas |
| methyl methacrylate | +119° | C. | Tsavalas |
| styrene | +104° | C. | Tsavalas |
| methacrylic acid | +185° | C. | Tsavalas |
| diacetone acrylamide | +85° | C. | supplier² |
| Plex ® (=25 wt. % | +85° | C. | own DSC measurement |

| | |
|---|---|
| ureidoethyl | on copolymer with MMA³ |
| methacrylate in MMA) | |

¹Tsavalas et al. Langmuir 2010, 26(10), 6960-6966
²https://www.gantrade.com/blog/daam-vs-adh
³calculated using the Tg value of UMA-MMA-copolymer determined by DSC, wherein the copolymer consists of 50 wt. % of Plex ® and 50 wt. % of MMA with respect to the total weight of the copolymer.
“pphm” refers to parts per hundred monomers, this permits to evaluate the amount of a given monomer in a monomer mixture relative to 100 parts of monomers forming the monomer mixture.
“Mw” refers to the weight average molecular weight.
“Mn” refers to the number average molecular weight.

The present invention is further illustrated by the following Examples.

### EXAMPLES

### Reference Example 1

### 1.1 Solid Content

The solid content was determined by drying a defined amount of the aqueous polymer dispersion (about 2 g) to constant weight in an aluminum crucible having an internal diameter of about 5 cm at 120° C. in a drying cabinet (2 hours). The ratio of the mass after drying to the mass before drying gave the solids content of the polymer latex. Two separate measurements were conducted. The value reported in the example is the mean of the two measurements.

### 1.2 Particle Size/Particle-Size Distribution (PSD)

The weight-average particle diameter of the polymer lattices/dispersion was determined by hydrodynamic fractionation techniques (HDC). Measurements were carried out using a PL-PSDA particle size distribution analyzer (Polymer Laboratories, Inc.). A small amount of sample of the polymer latex/dispersion of interest was injected into an aqueous eluent containing an emulsifier, resulting in a concentration of approximately 0.5 g/l. The mixture was pumped through a glass capillary tube of approximately 15 mm diameter packed with polystyrene spheres. As determined by their hydrodynamic diameter, smaller particles can sterically access regions of slower flow in capillaries, such that on average the smaller particles experience slower elution flow. The fractionation was finally monitored using an UV detector which measured the extinction at a fixed wavelength of 254 nm.

HDC mean is the weight-averaged mean-value of particle-size.

HDC peak denominates the peak maximum/peak maxima in particle-size distribution; sometimes also called “HDC mode”.

### 1.3 Viscosity

Viscosity was measured at 20° C. according to the standard method DIN EN ISO 3219:1994 using a “Brookfield RV”-type laboratory viscosimeter employing spindles #4 or #5 at 100 revolutions per minute.

### 1.4 pH Value

The pH values of the synthesized polymer lattices/dispersions were measured at ambient conditions utilizing a Portamess 913 pH-meter (from Knick Elektronische Messgeräte GmbH & Co. KG) equipped with a glass electrode from SI Analytics. The device is calibrated on regular terms with two buffer solutions (pH 7.00/pH 9.21).

### 1.5 Blocking Resistance

Blocking resistance was assessed as follows. 6 pine specimen (length: 150 mm; width: 50 mm; thickness: 5 mm) were oriented in parallel, side by side in direct contact. The wood specimen were cut in the same way (tangential cut) and the year rings be oriented in the same direction. In the middle zone of the panels the coating formulation described in Example 12 (Table 28) was applied by film applicator with a 300 micrometers wet layer. For the blocking resistance test only the 4 coated middle specimen were used.

The coating was dried for 24 h at 23° C./50% rel. humidity. 2 panels were stacked with the coated area, face to face, over cross. The same was done with the second set of panels. On the contact surface (50×50 mm) a weight of 10 kg (400 g/cm²) was placed the panels were stored at 23° C. in a climatized room (RH=50%). After 24 h, the weight was removed and the wood panels were separated by hand.

The blocking resistance was assessed by the power to separate panels by hand and by the extent of damage according to the following grades:
0=no adhesion (blocking), separates w/o force needed;
1=trace adhesion;
2=little adhesion;
3=mediocre adhesion;
4=strong adhesion;
5=very strong adhesion, not possible to separate panels by hand.

### 1.6 Whitening

Glass plates were conditioned/cleaned according to ISO 1522: A 100 microns wet film of the coating formulation described in Example 12 (Table 28) was cast by a film applicator (Erichsen Rakel) on cleaned glass and dried for 1 day at RT (23° C.) and RH (50%). A black background underneath the glass plates provides contrast. A large drop of DI-water (ca. 3 cm in diameter) is placed on the coating and the stopwatch is started. Photo-documentation and school notes (with 0=no water whitening and 5=opaque white) are given after different exposure times.

### 1.7 Rheology Measurements by Rheometer

Flow curves of the clear coats were determined with a rotational rheometer (Anton Paar MCR 302) in cone-plate geometry (CP50-1; S/N 44086), with the cone and plate at a distance of d=0.103 mm and a temperature of 23° C. The controlled shear rate (CSR) program is set as follows: after the material has been transferred to the measuring head and the cone has been lowered, the material is equilibrated for 120 s at 23° C. After this another equilibration period of 60 s at a shear rate 0.1 s⁻¹ is granted. Hereafter a forward loop with increasing shear rates from 0.1 s⁻¹ to 5000 s⁻¹ with 30 data points is started. The machine automatically calculates, at which shear rates it should measure, so that on a logarithmic scale the 30 data points on the x-axis displaying the shear rate are more or less equally spaced. For each datapoint it measures the torque (that is then calculated into a viscosity value by the software) until a.) there is, within statistical error, no change or b.) until 15 s have passed. Once the machine has measured the viscosity at a shear rate of 5000 s⁻¹ on the forward loop it initiates the so-called backward loop with the same 30 datapoints, once again logarithmically spaced, going back down to a shear rate of 0.1 s⁻¹. The software automatically generates plots with the viscosity displayed as a function of the different shear rates.

### Reference Example 2 Preparation of Stabilizer Dispersion (ASR-Stabilizers) According to EP 3194454

Four ASR-stabilizers 45, 47, 54 and 65 was prepared according to the procedure of the aforementioned PCT application and which is specified in the following:

A polymerization vessel equipped with metering devices and temperature regulation was charged at 20 to 25° C. (room temperature) under a nitrogen atmosphere with 1465.0 g of deionized water, 33.0 g of Adeka Reasoap SR-1025 (25 wt. % in aqueous solution-synthetic resin emulsion surfactant) and 52.1 g of an aqueous tetra-sodium pyrophosphate solution (3 wt. % strength). This initial charge was heated to 80° C. with stirring. When this temperature had been reached, 107.1 g of an aqueous sodium persulfate solution (7 wt. % strength) was added. Thereafter an emulsion feed (composition described below and in Table 1) was commenced and metered in over the course of 45 minutes. After the end of the emulsion feed, polymerization was continued for 10 minutes. Then, 67.3 g of an aqueous ammonia solution (25 wt. % strength, equimolar amount needed for 100% neutralization of methacrylic acid from the emulsion feed) and 9.4 g deionized water was added and stirred in for 10 minutes. The polymerization mixture was left to react further at 80° C. for another 90 minutes; finally, it was cooled to room temperature and filtered through a 125 μm filter.

Emulsion Feed for 45 (homogeneous mixture of):
351.7 g of deionized water
   11.0 g of Adeka Reasoap SR-1025 (25 wt. % in aqueous solution)
   85.0 g of methacrylic acid (MAA)
   68.0 g of a 25 wt. % strength solution of ureidoethyl methacrylate in methyl methacrylate (Plex)
527.0 g of methyl methacrylate (MMA)
   85.0 g of n-butyl acrylate (nBA)
425.0 g of a 20 wt. % strength aqueous solution of diacetoneacrylamide (DAAM)
   77.3 g of 2-ethylhexyl thioglycolate (EHTG)

For samples 44, 47, 54 and 65, the emulsion feed was adapted as well as the amount of ammonia solution as detailed in Table 1 below.

TABLE 1

| | | | | | | | | Solid | | Viscosity | HDC | HDC | Appearance |
|---|---|---|---|---|---|---|---|---|---|---|---|---|---|
| N. | nBA | MMA | Plex | MAA | DAAM | EHTG | D.N. | content | pH | (mPa · s) | mean | Peak | (naked eye) |
| 44 | 10.0 | 62.0 | 8.0 | 10.0 | 10.0 | 4.6 | 100% | 30.0 | 8.1 | 724 | — | — | clear |
| 45 | 10.0 | 62.0 | 8.0 | 10.0 | 10.0 | 9.1 | 100% | 28.1 | 8.2 | 40 | 218 | — | highly turbid |
| 47 | 10.0 | 57.0 | 8.0 | 15.0 | 10.0 | 9.1 | 100% | 27.4 | 7.9 | 104 | 67 | — | slightly |
| | | | | | | | | | | | | | turbid |
| 54 | 10.0 | 62.0 | 8.0 | 10.0 | 10.0 | 9.1 | 160% | 27.8 | 9.6 | 276 | — | — | clear |
| 65 | 10.0 | 62.0 | 8.0 | 10.0 | 10.0 | 9.1 | 200% | 28.2 | 9.9 | 184 | — | — | clear |

D.N.: degree of neutralization

The proportions of each ingredient (nBA, MMA, Plex, MAA, DAAM, EHTG) in Table 1 are given in pphm, namely based on the total amount of the monomers. The term “highly turbid” in Table 1 indicates that the mixture is almost opaque; “slightly turbid” indicates that the mixture is more transparent and exhibits a cloudy appearance whereas the term “clear” implies that we cannot see particles with naked eyes.
Mw(44)=9360 Da, Mw(45)=5240 Da, Mw(47)=5720 Da, Mw(54)=5240 Da, Mw(65)=5240 Da
Mn(44)=4580 Da, Mn(45)=2490 Da, Mn(47)=2650 Da, Mn(54)=2490 Da, Mn(65)=2490 Da

For samples 54 and 65, the degree of neutralization was increased to over 100% (base added in excess) such that it was possible to dissolve as much as possible the stabilizer.

As may be taken from Table 1, the viscosity of the stabilizer is high while the solid content is of only about 28-30 weight-% based on the total weight of the mixture. Due to this high viscosity the concentration of stabilizer which can be used for preparing a high-solid content aqueous polymer dispersion may only be of at most 20 pphm otherwise too much amount of water would be needed rendering impossible the reproducibility of the process. The obtained latex dispersions are disclosed in Comparative Examples 1-3 below.

### Comparative Example 1 Preparation of “High-Solids ASR-Stabilized Latex” not According to the Present Invention—12.5 Pphm of Stabilizer (=11.0 Weight-% of Stabilizer Based on the Total Weight of Stabilizer+Monomers)

The synthesis process was analog to WO 2014/053410 (Example 1):

A polymerization vessel equipped with metering devices and temperature regulation was charged at 20 to 25° C. (room temperature) under a nitrogen atmosphere with 84.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 2). 20 minutes after starting the emulsion feed, addition of 547.5 g of stabilizer dispersion 47 prepared according to Reference Example 2 was begun and fed in the polymerization vessel within 160 minutes in profile as described below (see Table 3). After the isochronic end of both feeds, polymerization was continued for another 15 minutes. Then 25.7 g of an aqueous sodium persulfate solution (7 wt. % strength) and 144.0 g of deionized water was added over a time period of 30 minutes, stirring was continued for another 30 minutes. The aqueous polymer dispersion obtained was then cooled to room temperature. At room temperature, 6.8 g of solid adipic dihydrazide were added. Lastly, the dispersion was filtered through a 125 μm filter.

The resulting aqueous polymer dispersion had a solid content of 61.0 weight-% based on the total weight of the aqueous polymer dispersion and a Brookfield viscosity of 2000 mPas (reduced to 560 mPas after dilution to 55 weight-% solid content). According to HDC analysis, the aqueous polymer dispersion has a multi-modal particle-size distribution with peaks at 370 nm, 0.7 micrometer and 1.4 micrometers.

Emulsion Feed (homogeneous mixture of):
108.0 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 2
Feed profile (emulsion feed)

| Time | Feed rate | Proportion of emulsion feed |
|---|---|---|
| 3 min | 111 g/h | 0.4% |
| 3 min | 169 g/h | 0.6% |
| 3 min | 227 g/h | 0.9% |
| 3 min | 287 g/h | 1.1% |
| 3 min | 345 g/h | 1.3% |
| 3 min | 403 g/h | 1.5% |
| 2 min | 456 g/h | 1.2% |
| 160 min | 460 g/h | 93.0% |

TABLE 3
Feed profile (stabilizer dispersion)

| | | |
|---|---|---|
| | | Proportion of stab. |
| Time | Feed rate | dispersion |

| | | | |
|---|---|---|---|
| 23 min | 18 | g/h | 1.3% |
| 23 min | 92 | g/h | 6.5% |
| 23 min | 165 | g/h | 11.6% |
| 23 min | 193 | g/h | 13.5% |
| 22 min | 269 | g/h | 18.0% |
| 21 min | 352 | g/h | 22.5% |
| 25 min | 349 | g/h | 26.6% |

### Comparative Example 2 Preparation of “High-Solids ASR-Stabilized Latex” not According to the Present Invention—20 Pphm of Stabilizer (=16.5 Weight-% of Stabilizer Based on the Total Weight of Stabilizer+Monomers) (Hard Phase)

A polymerization vessel equipped with metering devices and temperature regulation was charged at 20 to 25° C. (room temperature) under a nitrogen atmosphere with 84.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 4). 20 minutes after starting the emulsion feed, addition of 863.3 g of stabilizer dispersion 54 prepared according to Reference Example 2 was begun and fed in the polymerization vessel within 160 minutes at constant feed. After the isochronic end of both feeds, polymerization was continued for another 15 minutes. Then 25.7 g of an aqueous sodium persulfate solution (7 wt. % strength) was added over a time period of 30 minutes, stirring was continued for another 30 minutes. The aqueous polymer dispersion obtained was then cooled to room temperature. At room temperature, 10.9 g of solid adipic dihydrazide were added. Lastly, the dispersion was filtered through a 125 μm filter.

The resulting aqueous polymer dispersion had a solids content of 60.8 weight-% based on the total weight of the aqueous polymer dispersion and a Brookfield viscosity of 3320 mPas (reduced to 560 mPas after dilution to 55 weight-% solid content). According to HDC analysis, the aqueous polymer dispersion has a multi-modal particle-size distribution with two main peaks at 70 nm and 400 nm and another broad one at 0.7 micrometer. Such high particle size (micrometer range) is problematic for the storage of the latex.

Emulsion Feed (homogeneous mixture of):
132.0 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 4
Feed Profile (emulsion feed)

| Time | Feed rate | Proportion of emulsion feed |
|---|---|---|
| 3 min | 113 g/h | 0.4% |
| 3 min | 172 g/h | 0.6% |
| 3 min | 231 g/h | 0.9% |
| 3 min | 292 g/h | 1.1% |
| 3 min | 352 g/h | 1.3% |
| 3 min | 411 g/h | 1.5% |
| 2 min | 463 g/h | 1.2% |
| 160 min | 469 g/h | 93.0% |

### Comparative Example 3 Preparation of “High-Solids ASR-Stabilized Latex” not According to the Present Invention—20 Pphm of Stabilizer (=16.5 Weight-% of Stabilizer Based on the Total Weight of Stabilizer+Monomers) (Hard Phase)

A polymerization vessel equipped with metering devices and temperature regulation was charged at 20 to 25° C. (room temperature) under a nitrogen atmosphere with 210.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 195 minutes in a feed profile as described below (see Table 5). 20 minutes after starting the emulsion feed, addition of 851.1 g of stabilizer dispersion 65 prepared according to Reference Example 2 was begun and fed in the polymerization vessel within 175 minutes in profile as described below (see Table 6). After the isochronic end of both feeds, polymerization was continued for another 15 minutes. Then 25.7 g of an aqueous sodium persulfate solution (7 wt.-% strength) was added over a time period of 30 minutes, stirring was continued for another 30 minutes. The aqueous polymer dispersion obtained was then cooled to room temperature. At room temperature, 10.9 g of solid adipic dihydrazide were added. Lastly, the dispersion was filtered through a 125 μm filter.

The resulting aqueous polymer dispersion had a solids content of 54.2 weight-% based on the total weight of the aqueous polymer dispersion and a Brookfield viscosity of 490 mPas. According to HDC analysis, the aqueous polymer dispersion has a bi-modal particle-size distribution with peaks at 50 nm (35 weight-%) and 250 nm (65 weight-%).

Emulsion Feed (homogeneous mixture of):
276.0 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 5
Feed profile (emulsion feed)

| | | |
|---|---|---|
| Time | Feed rate | Proportion of emulsion feed |

| | | | |
|---|---|---|---|
| 3 | min | 125 g/h | 0.4% |
| 3 | min | 190 g/h | 0.6% |
| 3 | min | 256 g/h | 0.9% |
| 3 | min | 324 g/h | 1.1% |
| 3 | min | 389 g/h | 1.3% |
| 3 | min | 455 g/h | 1.5% |
| 2 | min | 512 g/h | 1.2% |
| 40 | min | 540 g/h | 24.3% |
| 15 | min | 0 g/h | — |
| 120 | min | 511 g/h | 68.7% |

TABLE 6
Feed profile (stabilizer dispersion)

| | | Proportion of stab. |
|---|---|---|
| Time | Feed rate | dispersion |
| 40 min | 160 g/h | 12.5 |
| 15 min | 1702 g/h | 50.0% |
| 120 min | 160 g/h | 37.5% |

### Reference Example 3 Preparation of Stabilizer Dispersions

Two dispersions 83 and 94 were prepared according to the following procedure:

A polymerization vessel equipped with metering devices and temperature regulation was charged at 20 to 25° C. (room temperature) under a nitrogen atmosphere with 1465.0 g of deionized water, 33.0 g of Adeka Reasoap SR-1025 (25 wt. % in aqueous solution-synthetic resin emulsion surfactant) and 52.1 g of an aqueous tetra-sodium pyrophosphate solution (3 wt. % strength). This initial charge was heated to 80° C. with stirring. When this temperature had been reached, 107.1 g of an aqueous sodium persulfate solution (7 wt. % strength) was added. Thereafter an emulsion feed (composition described below and in Table 1) was commenced and metered in over the course of 45 minutes. After the end of the emulsion feed, polymerization was continued for 10 minutes. The polymerization mixture was left to react further at 80° C. for another 90 minutes; finally, it was cooled to room temperature and filtered through a 125 μm filter.

Emulsion Feed for 83 (homogeneous mixture of):
351.7 g of deionized water
   11.0 g of Adeka Reasoap SR-1025 (25 wt. % in aqueous solution)
   85.0 g of methacrylic acid (MAA)
   68.0 g of a 25 wt. % strength solution of ureidoethyl methacrylate in methyl methacrylate (Plex)
527.0 g of methyl methacrylate (MMA)
   85.0 g of n-butyl acrylate (nBA)
425.0 g of a 20 wt. % strength aqueous solution of diacetoneacrylamide (DAAM)
   77.3 g of 2-ethylhexyl thioglycolate (EHTG)

Tg(S) of the polymer which would be obtained from polymerization of the monomers of the emulsion feed for 44, 45, 54, 65 and 83 is 93° C., said theoretical glass transition temperatures Tg(S₄₄), Tg(S₄₅), Tg(S₅₄), Tg(S₆₅), Tg(S₈₃) and Tg(S₉₄) are determined according to the Fox equation. Tg(S) of the polymer which would be obtained from polymerization of the monomers of the emulsion feed for 47 is 96° C., said theoretical glass transition temperature Tg(S47) is determined according to the Fox equation.

For sample 94, the emulsion feed was adapted as detailed in Table 7 below. For ease of comparison, the stabilizers 44, 45, 47, 54 and 65 prepared according to Reference Example 2 have been added to Table 7.

TABLE 7

| | | | | | | | | | | | HDC | HDC | |
|---|---|---|---|---|---|---|---|---|---|---|---|---|---|
| | | | | | | | | Solid | | Viscosity | mean | Peak | Appearance |
| N. | nBA | MMA | Plex | MAA | DAAM | EHTG | D.N. | content | pH | (mPa · s) | (nm) | (nm) | (naked eye) |
| 44 | 10.0 | 62.0 | 8.0 | 10.0 | 10.0 | 4.6 | 100% | 30.0% | 8.1 | 724 | — | — | clear |
| 45 | 10.0 | 62.0 | 8.0 | 10.0 | 10.0 | 9.1 | 100% | 28.1% | 8.2 | 40 | 218 | — | highly turbid |
| 47 | 10.0 | 57.0 | 8.0 | 15.0 | 10.0 | 9.1 | 100% | 27.4% | 7.9 | 104 | 67 | — | slightly |
| | | | | | | | | | | | | | turbid |
| 54 | 10.0 | 62.0 | 8.0 | 10.0 | 10.0 | 9.1 | 160% | 27.8% | 9.6 | 276 | — | — | clear |
| 65 | 10.0 | 62.0 | 8.0 | 10.0 | 10.0 | 9.1 | 200% | 28.2% | 9.9 | 184 | — | — | clear |
| 83 | 10.0 | 62.0 | 8.0 | 10.0 | 10.0 | 9.1 | 0% | 42.0% | 2.1 | 8 | 136 | 136 | colloid |
| 94 | 10.0 | 62.0 | 8.0 | 10.0 | 10.0 | 4.6 | 0% | 45.3% | 1.8 | 28 | 187 | 182 | colloid |

D.N.: degree of neutralization

The proportions of each ingredient (nBA, MMA, Plex, MAA, DAAM, EHTG) in Table 7 are given in pphm, namely based on the total amount of the monomers. The term “highly turbid” in Table 7 indicates that the mixture is almost opaque; “slightly turbid” indicates that the mixture is more transparent and exhibits a cloudy appearance whereas the term “clear” implies that we cannot see particles with naked eyes.
Mw(83)=5240 Da, Mw(94)=9360 Da
Mn(83)=2490 Da, Mn(94)=4580 Da

As may be taken from Table 7, compared to the viscosity of the stabilizer dispersions prepared in Reference Example 2, the viscosity of the inventive stabilizer dispersions was greatly reduced while the solid content has been increased from about 28 weight-% to 42 and 45.3 weight-% based on the total weight of the mixture. This is also true for the one where a lower amount of chain-transfer agent has been employed (N.94): despite its higher molecular weight (normally going hand in hand with higher viscosity) this stabilizer dispersion is easy to handle. Without wanting to be bound to any theory, it is believed that these great properties of stabilizer are obtained thanks to the acidity of the colloid.

### Example 1 Preparation of a High-Solid Content Aqueous Polymer Dispersion According to the Present Invention—20 Pphm of Stabilizer (=16.5 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 83.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 378.0 g of deionized water and 43.5 g of Acronal® A 508. This initial charge was heated to 80° C. with stirring. When this temperature had been reached, a homogenous solution of 3.0 g sodium persulfate (initiator) in 39.9 g deionized water was added and stirring took place for 3 minutes. Thereafter an emulsion feed (composition described below) was commenced and was metered in over the course of 195 minutes in a feed profile as described below (see Table 8). 20 minutes after starting the emulsion feed, the reactor was charged with 29.8 g of an aqueous ammonia solution (25 wt. % NH₄OH—D.N=100%) and addition of 571.4 g of stabilizer dispersion 83 prepared in 1. was begun and fed in the polymerization vessel within 175 minutes in profile as described below (see Table 9). After the isochronic end of both feeds, polymerization was continued for another 15 minutes. Then 25.7 g of an aqueous sodium persulfate solution (7 wt. % sodium persulfate) was added over a time period of 30 minutes, stirring was continued for another 30 minutes. The aqueous polymer dispersion obtained was then cooled to room temperature. At room temperature, 10.9 g of solid adipic dihydrazide were added. Lastly, the dispersion was filtered through a 125 μm filter.

The resulting aqueous polymer dispersion had a solids content of 54.6 weight-% and a Brookfield viscosity of 265 mPas. According to HDC analysis, the aqueous polymer dispersion has a bi-modal particle-size distribution with peaks at 70 nm (55 weight-%) and 220 nm (45 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

Tg(E) of the polymer which would be obtained from polymerization of the monomers of the emulsion feed is −10° C., said theoretical glass transition temperature Tg(E) is determined according to the Fox equation. Said Tg(E) is the same for Examples 2-11.

TABLE 8
Feed profile (emulsion feed)

| | | |
|---|---|---|
| Time | Feed rate | Proportion of emulsion feed |

| | | | |
|---|---|---|---|
| 3 | min | 125 g/h | 0.4% |
| 3 | min | 190 g/h | 0.6% |
| 3 | min | 256 g/h | 0.9% |
| 3 | min | 324 g/h | 1.1% |
| 3 | min | 389 g/h | 1.3% |
| 3 | min | 455 g/h | 1.5% |
| 2 | min | 512 g/h | 1.2% |
| 55 | min | 540 g/h | 32.0% |
| 15 | min | 0 g/h | — |
| 105 | min | 511 g/h | 61.0% |

TABLE 9
Feed profile (stabilizer dispersion)

| | | Proportion of stabilizer |
|---|---|---|
| Time | Feed rate | dispersion feed |
| 55 min | 109 g/h | 17.2% |
| 15 min | 1163 g/h | 50.0% |
| 105 min | 109 g/h | 32.8% |

Compared to Comparative Example 3 which uses the excessively neutralized stabilizer (D.N.=200%) with lower solid content and higher viscosity, the obtained high-solid content aqueous dispersion based on the acidic, in-situ neutralized stabilizer presents reduced viscosity even at slightly higher solids content.

### Example 2 Preparation of a High-Solid Content Aqueous Polymer Dispersion According to the Present Invention—20 Pphm of Stabilizer (=16.5 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 408.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 195 minutes in a feed profile as described below (see Table 10). 20 minutes after starting the emulsion feed, the reactor was charged with 17.7 g of an aqueous ammonia solution (25 wt. % NH₄OH—D.N=100%) and addition of 533.3 g of stabilizer dispersion 94 prepared in 1. was begun and fed in the polymerization vessel within 175 minutes in profile as described below (see Table 11). After the isochronic end of both feeds, polymerization was continued for another 15 minutes. Then 25.7 g of an aqueous sodium persulfate solution (7 wt. % sodium persulfate) was added over a time period of 30 minutes, stirring was continued for another 30 minutes. The aqueous polymer dispersion obtained was then cooled to room temperature. At room temperature, 10.9 g of solid adipic dihydrazide were added. Lastly, the dispersion was filtered through a 125 μm filter.

The resulting aqueous polymer dispersion had a solids content of 54.9 weight-% and a Brookfield viscosity of 345 mPas. According to HDC analysis, the aqueous polymer dispersion has a bi-modal particle-size distribution with peaks at 55 nm (35 weight-%) and 240 nm (65 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 10
Feed profile (emulsion feed)

| | | |
|---|---|---|
| Time | Feed rate | Proportion of emulsion feed |

| | | | |
|---|---|---|---|
| 3 | min | 132 g/h | 0.4% |
| 3 | min | 201 g/h | 0.6% |
| 3 | min | 270 g/h | 0.9% |
| 3 | min | 343 g/h | 1.1% |
| 3 | min | 412 g/h | 1.3% |
| 3 | min | 481 g/h | 1.5% |
| 2 | min | 542 g/h | 1.2% |
| 55 | min | 549 g/h | 32.0% |
| 15 | min | 0 g/h | — |
| 105 | min | 548 g/h | 61.0% |

TABLE 11
Feed profile (stabilizer dispersion)

| | | Proportion of stab. |
|---|---|---|
| Time | Feed rate | dispersion |
| 55 min | 109 g/h | 17.2% |
| 15 min | 1163 g/h | 50.0% |
| 105 min | 109 g/h | 32.8% |

### Example 3 Preparation of an High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 195 minutes in the same feed profile as Example 2. 20 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 175 minutes in profile as described below (see Table 12). After the isochronic end of both feeds, polymerization was continued for another 15 minutes. Then 25.7 g of an aqueous sodium persulfate solution (7 wt. % sodium persulfate) was added over a time period of 30 minutes, stirring was continued for another 30 minutes. The aqueous polymer dispersion obtained was then cooled to room temperature. At room temperature, 16.4 g of solid adipic dihydrazide were added. Lastly, the dispersion was filtered through a 125 μm filter.

The resulting aqueous polymer dispersion had a solids content of 54.9 weight-% and a Brookfield viscosity of 1040 mPas. According to HDC analysis, the aqueous polymer dispersion has a bi-modal particle-size distribution with peaks at 50 nm (35 weight-%) and 240 nm (65 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 12
Feed profile (stabilizer dispersion)

| | | Proportion of stab. |
|---|---|---|
| Time | Feed rate | dispersion |
| 55 min | 104 g/h | 11.6% |
| 15 min | 1103 g/h | 33.7% |
| 105 min | 256 g/h | 54.7% |

### Example 4 Preparation of an High-Solid Content Aqueous Polymer Dispersion According to the Present Invention—40 Pphm of Stabilizer (=28.3 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 312.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 195 minutes in the same feed profile as in Example 2. 20 minutes after starting the emulsion feed, the reactor was charged with 35.5 g of an aqueous ammonia solution (25 wt. % NH₄OH—D.N=100%) and addition of 1066.7 g of stabilizer dispersion 94 prepared in 1. was begun and fed in the polymerization vessel within 175 minutes in profile as described below (see Table 13). After the isochronic end of both feeds, polymerization was continued for another 15 minutes. Then 25.7 g of an aqueous sodium persulfate solution (7 wt. % sodium persulfate) was added over a time period of 30 minutes, stirring was continued for another 30 minutes. The aqueous polymer dispersion obtained was then cooled to room temperature. At room temperature, 21.8 g of solid adipic dihydrazide were added. Lastly, the dispersion was filtered through a 125 μm filter.

The resulting aqueous polymer dispersion had a solids content of 55.1 weight-% and a Brookfield viscosity of 4600 mPas. This high viscosity compared to Examples 1 to 3 is obtained due to the significantly increased amount of stabilizer. Thanks to the process of the present invention, it is still possible to obtain an aqueous polymer dispersion which such high amount of stabilizer while it would not be achievable with processes according to the prior art. According to HDC analysis, the aqueous polymer dispersion has a bi-modal particle-size distribution with peaks at 40 nm (50 weight-%) and 240 nm (50 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 13
Feed profile (stabilizer dispersion)

| | | Proportion of stab. |
|---|---|---|
| Time | Feed rate | dispersion |
| 55 min | 103 g/h | 8.7% |
| 15 min | 1085 g/h | 25.0% |
| 105 min | 411 g/h | 66.3% |

### Example 5 Preparation of a High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 14). 20 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 160 minutes at constant feed. 90 minutes after starting the emulsion feed, 25.7 g of an aqueous sodium persulfate solution (7 wt. % sodium persulfate) was added over a time period of 90 minutes. After the isochronic end of all feeds, polymerization was continued for another 105 minutes and 16.4 g of solid adipic dihydrazide were added. The aqueous polymer dispersion obtained was then cooled to room temperature and, lastly, filtered through a 125 μm filter.

The resulting aqueous polymer dispersion had a solids content of 55.1 weight-% and a Brookfield viscosity of 2240 mPas. According to HDC analysis, the aqueous polymer dispersion has a bi-modal particle-size distribution with peaks at 35 nm (60 weight-%) and 210 nm (40 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 14
Feed profile (emulsion feed)

| Time | Feed rate | Proportion of emulsion feed |
|---|---|---|
| 20 min | 330 g/h | 7.0% |
| 160 min | 548 g/h | 93.0% |

### Example 6 Preparation of a High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 15). 30 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 150 minutes at constant feed. 90 minutes after starting the emulsion feed, 25.7 g of an aqueous sodium persulfate solution (7 wt. % sodium persulfate) was added over a time period of 90 minutes. After the isochronic end of all feeds, polymerization was continued for another 105 minutes and 16.4 g of solid adipic dihydrazide were added. The aqueous polymer dispersion obtained was then cooled to room temperature and, lastly, filtered through a 125 μm filter.

The resulting aqueous polymer dispersion had a solids content of 54.9 weight-% and a Brookfield viscosity of 1640 mPas. According to HDC analysis, the aqueous polymer dispersion has a bi-modal particle-size distribution with peaks at 50 nm (50 weight-%) and 210 nm (50 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 15
Feed profile (emulsion feed)

| Time | Feed rate | Proportion of emulsion feed |
|---|---|---|
| 30 min | 314 g/h | 10.0% |
| 150 min | 566 g/h | 90.0% |

### Example 7 Preparation of a High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 16). 40 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 140 minutes at constant feed. 90 minutes after starting the emulsion feed, 25.7 g of an aqueous sodium persulfate solution (7 wt. % sodium persulfate) was added over a time period of 90 minutes. After the isochronic end of all feeds, polymerization was continued for another 105 minutes and 16.4 g of solid adipic dihydrazide were added. The aqueous polymer dispersion obtained was then cooled to room temperature and, lastly, filtered through a 125 μm filter. The resulting aqueous polymer dispersion had a solids content of 54.9 weight-% and a Brookfield viscosity of 1640 mPas. According to HDC analysis, the aqueous polymer dispersion has a bi-modal particle-size distribution with peaks at 40 nm (45 weight-%) and 240 nm (55 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 16
Feed Profile (emulsion feed)

| Time | Feed rate | Proportion of emulsion feed |
|---|---|---|
| 40 min | 307 g/h | 13.0% |
| 140 min | 586 g/h | 87.0% |

### Example 8 Preparation of a High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 17). 60 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 120 minutes at constant feed. 90 minutes after starting the emulsion feed, 25.7 g of an aqueous sodium persulfate solution (7 wt. % sodium persulfate) was added over a time period of 90 minutes. After the isochronic end of all feeds, polymerization was continued for another 105 minutes and 16.4 g of solid adipic dihydrazide were added. The aqueous polymer dispersion obtained was then cooled to room temperature and, lastly, filtered through a 125 μm filter. The resulting aqueous polymer dispersion had a solids content of 54.7 weight-% and a Brookfield viscosity of 880 mPas. According to HDC analysis, the aqueous polymer dispersion has a bi-modal particle-size distribution with peaks at 35 nm (25 weight-%) and 240 nm (75 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 17
Feed profile (emulsion feed)

| Time | Feed rate | Proportion of emulsion feed |
|---|---|---|
| 60 min | 314 g/h | 20.0% |
| 120 min | 629 g/h | 80.0% |

### Example 9 Preparation of a High-Solid Content Aqueous Polymer Dispersion According to the Present Invention—30 Pphm of Stabilizer (=22.8 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 360.0 g of deionized water and 43.5 g of Acronal® A 508. This initial charge was heated to 80° C. with stirring. When this temperature had been reached, a homogenous solution of 3.0 g sodium persulfate in 39.9 g deionized water was added and stirring took place for 3 minutes. Thereafter an emulsion feed (composition described below) was commenced and was metered in over the course of 180 minutes in a feed profile as described below (see Table 18). 75 minutes after starting the emulsion feed, the reactor was charged with 26.6 g of an aqueous ammonia solution (25 wt. % NH₄OH—D.N=100%) and addition of 800.0 g of stabilizer dispersion 94 prepared in 1. was begun and fed in the polymerization vessel within 105 minutes at constant feed. 90 minutes after starting the emulsion feed, 25.7 g of an aqueous sodium persulfate solution (7 wt. % sodium persulfate) was added over a time period of 90 minutes. After the isochronic end of all feeds, polymerization was continued for another 105 minutes and 16.4 g of solid adipic dihydrazide were added. The aqueous polymer dispersion obtained was then cooled to room temperature and, lastly, filtered through a 125 μm filter. The resulting aqueous polymer dispersion had a solids content of 54.8 weight-% and a Brookfield viscosity of 840 mPas. According to HDC analysis, the aqueous polymer dispersion has a bi-modal particle-size distribution with peaks at 30 nm (20 weight-%) and 270 nm (80 weight-%).

Emulsion Feed (homogeneous mixture of):
362.4 g of deionized water
   9.6 g of Adeka Reasoap SR-1025 (25 wt. % aqueous solution)
360.0 g of n-butyl acrylate
408.0 g of 2-ethylhexyl acrylate
432.0 g of methyl methacrylate

TABLE 18
Feed profile (emulsion feed)

| Time | Feed rate | Proportion of emulsion feed |
|---|---|---|
| 75 min | 314 g/h | 20.0% |
| 105 min | 674 g/h | 80.0% |

### Example 10 Preparation of a High-Solid Content Aqueous Polymer Dispersion According to the Present Invention—40 Pphm of Stabilizer (=28.3 Weight-% of Stabilizer Based on the Total Weight of Stabilizer+Monomers)

### 1. Preparation of a Stabilizer Dispersion

The dispersion was prepared as detailed in Reference Example 3 for obtaining a dispersion 94.

### 2. Preparation of the High-Solid Content Aqueous Polymer Dispersion (Bi-Modal Particular Size Distribution)

A polymerization vessel equipped with metering devices and temperature regulation was charged at 20 to 25° C. (room temperature) under a nitrogen atmosphere with 182.0 g of deionized water and 25.4 g of Acronal® A 508. This initial charge was heated to 80° C. with stirring. When this temperature had been reached, a homogenous solution of 1.75 g sodium persulfate in 23.25 g deionized water was added and stirring took place for 3 minutes. Thereafter an emulsion feed (composition described below) was commenced and was metered in over the course of 195 minutes in a feed profile as described below (see Table 19). 20 minutes after starting the emulsion feed, the reactor was charged with 20.7 g of an aqueous ammonia solution (25 wt. % NH₄OH—D.N=100%) and addition of 622.2 g of stabilizer dispersion 94 was begun and fed in the polymerization vessel within 195 minutes in profile as described below (see Table 20). 95 minutes after starting the emulsion feed, 15.0 g of an aqueous sodium persulfate solution (7 wt. % sodium persulfate) was added over a time period of 120 minutes. After the isochronic end of all feeds, polymerization was continued for another 45 minutes. The aqueous polymer dispersion obtained was then cooled to room temperature. At room temperature, 12.7 g of solid adipic dihydrazide were added. Lastly, the dispersion was filtered through a 125 μm filter.

The resulting aqueous polymer dispersion had a solids content of 54.7 weight-% and a Brookfield viscosity of 6300 mPas. This high viscosity is obtained due to the amount of stabilizer. Thanks to the process of the present invention, it is still possible to obtain an aqueous polymer dispersion which such high amount of stabilizer while it would not be achievable with processes according to the prior art. According to HDC analysis, the aqueous polymer dispersion has a bi-modal particle-size distribution with peaks at 35 nm (45 weight-%) and 260 nm (55 weight-%).

Emulsion Feed (homogeneous mixture of):
211.4 g of deionized water
   5.6 g of Adeka Reasoap SR-1025 (25 wt. % aqueous solution)
210.0 g of n-butyl acrylate
238.0 g of 2-ethylhexyl acrylate
252.0 g of methyl methacrylate

TABLE 19
Feed Profile (emulsion feed)

| Time | Feed rate | Proportion of emulsion feed |
|---|---|---|
| 20 min | 193 g/h | 7.0% |
| 60 min | 293 g/h | 32.0% |
| 15 min | 0 g/h | — |
| 120 min | 280 g/h | 61.0% |

TABLE 20
Feed Profile (stabilizer dispersion)

| | | Proportion of stab. |
|---|---|---|
| Time | Feed rate | dispersion |
| 60 min | 31 g/h | 5.0% |
| 15 min | 633 g/h | 25.0% |
| 120 min | 221 g/h | 70.0% |

### Example 11 Preparation of a High-Solid Content Aqueous Polymer Dispersion According to the Present Invention

1. and 2. of Example 10 were repeated with the difference that in 2. only 16.6 g of an aqueous ammonia solution (25 wt. % strength, D.N=80%) was added to partially neutralize stabilizer dispersion 94.

The resulting aqueous polymer dispersion had a solid content of 54.8 weight-% and a Brookfield viscosity of 1400 mPas which is significantly lower compared to full neutralization as in Example 10. According to HDC analysis, the aqueous polymer dispersion has a bi-modal particle-size distribution with peaks at 45 nm (40 weight-%) and 260 nm (60 weight-%).

### Comparative Example 4 Preparation of an Aqueous Polymer Dispersion with a Solid Content of 43 wt % not According to the Present Invention

### 1. Preparation of a Stabilizer Dispersion A

The dispersion A was prepared as detailed in Example 3 of EP 3194454. The proportions of monomers are as in defined in “Zulauf 2” in EP 3194454 and summarized below.

TABLE 21

| | | | | | | | | Solid | | Viscosity | HDC | HDC | Appearance |
|---|---|---|---|---|---|---|---|---|---|---|---|---|---|
| N. | nBA | MMA | Plex | MAA | DAAM | EHTG | D.N. | content | pH | (mPa · s) | mean | Peak | (naked eye) |
| A | 10.0 | 63.8 | 6.2 | 10.0 | 10.0 | 4.6 | 100% | 28.3% | 7.8 | 40 | — | — | clear |

Tg of the polymer which would be obtained from polymerization of the monomers of the emulsion feed for A is 94° C., said theoretical glass transition temperature Tg (A) is determined according to the Fox equation.

### 2. Preparation of an Aqueous Polymer Dispersion

The recipe of Example 3 of EP 3194454 was repeated and an aqueous polymer dispersion having a solid content of 43 wt. % based on the weight of the dispersion, a pH of 8.1, a viscosity of 1070 mPas, a monomodal particle size, and a particle size (median) of 32 nm, was obtained.

### Example 12 Preparation of Industrial Coatings Using the Aqueous Polymer Dispersions of Examples 2-9 as Binders and of Comparative Example 4 as Reference Binder—Testing of the Obtained Coatings

Nine clear coat formulations have been prepared by
forming a paste: by mixing the components listed in Table 27 below for 1 min at 800 rpm (rounds/revolutions per minute), then 1 min at 1000 rpm, then 2 min at 1250 rpm and finally 2 min 30 s at 1600 rpm
adding a binder, namely a dispersion of Examples 2 to 9 or a dispersion of Comparative Example 4 (polymer dispersion having a solid content of 43 wt. % based on the weight of the dispersion, pH of 8.1, viscosity of 1070 mPas, monomodal particle size, particle size (median) 32 nm), to the paste with water and a defoaming agent as detailed in Table 27, then mixing for 1 min at 1000 rpm, then 1 min at 1250 rpm and finally 1 min 30 s at 1600 rpm.

This formulation recipe shows a simple 1:1 exchange of a dispersion with standard solid content (43 wt. % as in the reference binder) and with the dispersions according to the invention (with solids content of about 55 wt. %). No efforts were done in this first instance to reformulate with respect to rheology, coalescent demand and/or defoamer level, as this would require an individual optimization for each and every example, which is beyond the scope of the invention. Suffice to say that thickener response of the high solids examples according to the invention is higher (all fall within the shaded grey area above the original flow curve of Comparative Example 4), resulting in higher viscosities over a shear rate from 0.1-5000 s⁻¹. Moreover, the flow curve has a slightly different shape (FIG. 1). A person skilled-in-the-art would expect different behavior and could embark on an optimization of the thickener levels (with a stronger reduction of the mid-shear thickener than of the high shear thickener amount, and a potential switch to more Newtonian thickener, for example) that will likely bring back the original shape of the flow curve as with the standard dispersion (reference binder), if this is then desired. Alternatively, the particle size distribution may be optimized and/or the interaction between such associative thickeners and the binder surface. Importantly though, these clear coat formulations can still be easily applied, whether by the drawdown methods described in Reference Example 1 for assessment of water whitening and blocking resistance or indeed by ‘real-life’ application methods like spray application.

Further, these clear coat formulations were applied and assessed in terms of water whitening and blocking resistance as described under Reference Example 1.4 and 1.5 (vide infra) with the results shown in Table 28. It is important to note that the same wet thickness has been applied by drawdown bar, which implies that the dry film thickness for the high solids examples according to the invention is proportionally higher than for the standard binder. This represents a worst-case scenario in terms of the assessed (early) film properties, as thicker films translate into slower development of resistance properties and mechanical properties.

Table 28 displays the results on water whitening. The differences are relatively minor: the starting point for the standard binder (reference binder) starts out slightly worse, but the end point of the visual assessment is more or less the same.

The blocking resistance (measured in duplo) shows that the blocking resistance for the high solids binders (new binders of Examples 2-9) is slightly worse than for the reference binder. The performance of the high solids binders compared with one another can be explained by the different amounts, the overall hardness of the hard phase and the distribution of this hard phase over the different binder particles. In comparison with the reference binder (Example 3 of EP 3 194 454) the blocking resistance of the high solids binder with the highest amount of hard phase (Example 4 with 40 pphm stabilizer) is still worse. The overall lower amount of stabilizer acting as hard phase in Example 4 vs that in Example 3 of EP 3 194 454 could in part explain the results. But as mentioned earlier, also because of the fact that the dry layer thickness at equal wet layer thickness is going to be higher for the high solids versions, the development of blocking resistance may be at a later stage versus Example 3 of EP 3 194 454. This prompted us to devise an experiment in which a constant dry layer thickness was targeted. For this we used the formulation with the high solids binder from Example 4. A drawdown bar of 240 microns was used for the high solids binder and for the reference binder the previously tested drawdown bar with 300 microns was used. This resulted in measured dry layer thicknesses (by crosscut) of 81 and 84 microns for the clear coat with the reference binder and with the high solid binder of Example 4, respectively. After a drying time of 24 hours at room temperature the panels were stacked face-to-face with a pressure of 400 g/cm², as described in Reference Example 1.5. The result was identical with tack and seal both at 0.0.

Encouraged by this experiment (targeting the same dry layer thickness) the drying time before stacking the panels face-to-face was shortened. Blocking conditions were the same as described above. A clear advantage of the faster build-up of the mechanical properties can be seen for the high solids binder in the inventive formulations.

TABLE 27

| | | | Dispersion of | | | | |
|---|---|---|---|---|---|---|---|
| | | | C. E. 4 | Ex. 2 | Ex. 3 | Ex. 4 | Ex. 5 |
| | | | Solid content | | | | |
| Components | Solid content | density | 43.0% | 54.9% | 54.9% | 55.1% | 55.1% |
| DI-water 01 | 0% | 1 | 50.00 | 50.00 | 50.00 | 50.00 | 50.00 |
| Tego Foamex 810 | 100.0% | 0.95 | 4.00 | 4.00 | 4.00 | 4.00 | 4.00 |
| BDG | 0.0% | 0.95 | 20.00 | 20.00 | 20.00 | 20.00 | 20.00 |
| Tinuvin 1130 | 30% | 1.17 | 5.00 | 5.00 | 5.00 | 5.00 | 5.00 |
| Surfinol AD 01 | 100% | 1.05 | 1.00 | 1.00 | 1.00 | 1.00 | 1.00 |
| Acticide MBS | 20.0% | 1 | 2.00 | 2.00 | 2.00 | 2.00 | 2.00 |
| Ammonia | 25.0% | 0.91 | 2.00 | 2.00 | 2.00 | 2.00 | 2.00 |
| (−>pH 8, 8-9) | | | | | | | |
| Rheovis PU1291 | 45.0% | 1.05 | 12.00 | 12.00 | 12.00 | 12.00 | 12.00 |
| Rheovis PU1340 | 20.0% | 1.05 | 20.00 | 20.00 | 20.00 | 20.00 | 20.00 |
| Mixing: 1 min @ 800 Upm, 1 min @ 1000 Upm, | | | | | | | |
| 2 min @ 1250 Upm, 2.30 min @ 1600 Upm | | | | | | | |
| Binder (=dispersion as mentioned above) | | | 752.82 | 767.94 | 767.94 | 765.15 | 765.15 |
| DI-water 03 | 0% | 1 | 128.18 | 113.06 | 113.06 | 115.85 | 115.85 |
| Tego Airex 902W | 100.0% | 0.95 | 3.00 | 3.00 | 3.00 | 3.00 | 3.00 |

| Mixing: 1 min @ 800 Upm, 1 min @ 1000 Upm, | | | | | | | |
|---|---|---|---|---|---|---|---|
| 1 min @ 1250 Upm, 1.30 min @ 1600 Upm | | | | | | | |
| Σ | | | 1000.00 | 1000.00 | 1000.00 | 1000.00 | 1000.00 |
| Solid content | | | 34.1% | 44.1% | 44.1% | 44.1% | 44.1% |
| | | | | Dispersion of | | | |
| | | | | Ex. 6 | Ex. 7 | Ex. 8 | Ex. 9 |
| | | | | Solid content | | | |
| | Components | Solid content | density | 54.9% | 54.9% | 54.7% | 54.8% |
| | DI-water 01 | 0% | 1 | 50.00 | 50.00 | 50.00 | 50.00 |
| | Tego Foamex 810 | 100.0% | 0.95 | 4.00 | 4.00 | 4.00 | 4.00 |
| | BDG | 0.0% | 0.95 | 20.00 | 20.00 | 20.00 | 20.00 |
| | Tinuvin 1130 | 30% | 1.17 | 5.00 | 5.00 | 5.00 | 5.00 |
| | Surfinol AD 01 | 100% | 1.05 | 1.00 | 1.00 | 1.00 | 1.00 |
| | Acticide MBS | 20.0% | 1 | 2.00 | 2.00 | 2.00 | 2.00 |
| | Ammonia | 25.0% | 0.91 | 2.00 | 2.00 | 2.00 | 2.00 |
| | (−>pH 8, 8-9) | | | | | | |
| | Rheovis PU1291 | 45.0% | 1.05 | 12.00 | 12.00 | 12.00 | 12.00 |
| | Rheovis PU1340 | 20.0% | 1.05 | 20.00 | 20.00 | 20.00 | 20.00 |
| | Mixing: 1 min @ 800 Upm, 1 min @ 1000 Upm, | | | | | | |
| | 2 min @ 1250 Upm, 2.30 min @ 1600 Upm | | | | | | |
| | Binder (=dispersion as mentioned above) | | | 767.94 | 767.94 | 770.75 | 769.34 |
| | DI-water 03 | 0% | 1 | 113.06 | 113.06 | 110.25 | 111.66 |
| | Tego Airex 902W | 100.0% | 0.95 | 3.00 | 3.00 | 3.00 | 3.00 |

| | | | | |
|---|---|---|---|---|
| Mixing: 1 min @ 800 Upm, 1 min @ 1000 Upm, | | | | |
| 1 min @ 1250 Upm, 1.30 min @ 1600 Upm | | | | |
| Σ | 1000.00 | 1000.00 | 1000.00 | 1000.00 |
| Solid content | 44.1% | 44.1% | 44.1% | 44.1% |

Tego Foamex 810: defoamer; BDG: butyl diglycol; Tinuvin 1130: UV absorber/stabilizer; Surfinol AD 01: wetting agent; Acticide MBS; in-can preservative; Rheovis PU1291/Rheovis PU1340: PU thickeners and Tego Airex 902W: defoamer/deaire.

TABLE 28

| | | | Coating with binder of | | | | | | | | |
|---|---|---|---|---|---|---|---|---|---|---|---|
| | After | | C. E. 4 | Ex. 2 | Ex. 3 | Ex. 4 | Ex. 5 | Ex. 6 | Ex. 7 | Ex. 8 | Ex. 9 |
| Whitening | 15 | min | 1.0 | 0.2 | 0.2 | 0.2 | 0.2 | 0.2 | 0.2 | 0.2 | 0.2 |
| | 30 | min | 1.0 | 0.5 | 0.5 | 0.5 | 0.5 | 0.5 | 0.5 | 0.5 | 0.5 |
| | 1 | h | 1.0 | 0.5 | 0.5 | 0.5 | 0.5 | 0.5 | 0.5 | 0.5 | 0.5 |
| | 2 | h | 2.0 | 2.0 | 2.0 | 2.0 | 2.0 | 2.0 | 2.0 | 2.0 | 2.0 |
| | 3 | h | 3.0 | 3.0 | 3.0 | 3.0 | 3.0 | 3.0 | 3.0 | 3.0 | 3.0 |
| | 4 | h | 3.0 | 3.0 | 3.5 | 3.5 | 3.5 | 3.5 | 3.5 | 3.5 | 3.5 |
| Blocking/300 μm | tack (0-5) | | 0.0 | 2.0 | 1.5 | 0.5 | 1.0 | 0.5 | 0.5 | 1.0 | 0.5 |
| 24 h drying RT | seal (0-5) | | 0.0 | 0.0 | 0.0 | 0.0 | 0.0 | 0.0 | 0.0 | 0.0 | 0.0 |
| RT 400 g/cm³ [10 | | | | | | | | | | | |
| Kg] | | | | | | | | | | | |
| Blocking/300 μm | tack (0-5) | | 0.0 | 2.0 | 1.0 | 0.5 | 1.0 | 0.5 | 0.5 | 0.5 | 0.5 |
| 24 h drying RT | seal (0-5) | | 0.0 | 0.0 | 0.0 | 0.0 | 0.0 | 0.0 | 0.0 | 0.0 | 0.0 |
| RT 400 g/cm³ [10 | | | | | | | | | | | |
| Kg] | | | | | | | | | | | |

RT: room temperature
0 is good
5 is bad

TABLE 29

| | | 24 h | 12 h | 8 h | 4 h | 2 h |
|---|---|---|---|---|---|---|
| C. Ex. 4 | Tack | 0.0 | 0.0 | 2.0 | 4.0 | 5.0 |
| | Seal | 0.0 | 0.0 | 0.0 | 2.0 | 5.0 |
| Ex. 4 | Tack | 0.0 | 0.0 | 0.0 | 2.0 | 4.0 |
| | Seal | 0.0 | 0.0 | 0.0 | 0.0 | 4.0 |

The clear coat formulations prepared with the dispersion of Example 4 and with the dispersion of Comparative Example 4 were applied and dried for several durations 24 h, 12 h, 8 h, 4 h and 2 h.

After 24 h and 12 h drying, it is observed that the tack/seal are the same at 0 (good). After 8 h drying of the inventive formulation the properties are as good as after 12 h drying of the standard (comparative) formulation. After only 4 h drying, the tack is at 2 and the seal is already at 0 when using the dispersion of Example 4 (inventive) while the tack is at 4 and the seal at 2 for the formulation which was prepared with the dispersion of Comparative Example 4. Improvement can already be seen after only 2 h drying compared to the standard formulation.

### BRIEF DESCRIPTION OF THE FIGURE

FIG. 1 shows the viscosity over a shear rate from 0.1-5000 s⁻¹ for the formulations of Examples 2 to 9 and of Comparative Example 4. As may be taken from the FIGURE, all viscosities measured for the inventive samples fall within the grey area (particular profile) different to the viscosity profile for the comparative sample.

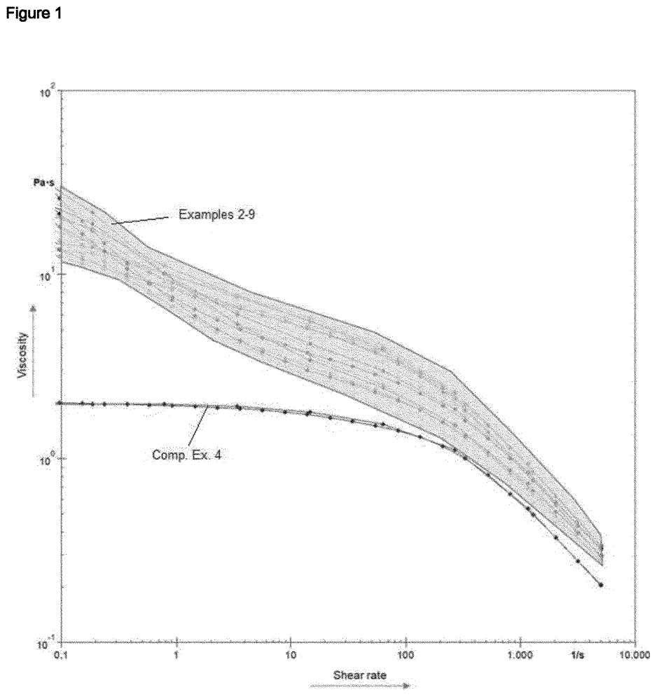

### CITED LITERATURE

EP3194454 B1
EP3670552 A1
WO2014/053410 A
Tsavalas et al., Langmuir 2010, 26 (10), 6960-6966
Ullmann's Encyclopedia of Industrial Chemistry (vol. A21, page 169, 5th Edition, Verlag Chemie, Weinheim, 1992)
J. Brandrup, E. H. Immergut, Polymer Handbook, 1st Edition—J. Wiley, New York 1966, 2nd Edition—J. Wiley, New York 1975, and 3rd Edition—J. Wiley, New York 1989

1.-15. (canceled)

16. A process for preparing an aqueous polymer dispersion having a polymer content of at least 50 weight-% based on the total weight of the aqueous polymer dispersion, the process comprising
(i) preparing a stabilizer dispersion, comprising
subjecting ethylenically unsaturated monomers comprising monomers which exhibit a Bronsted acidic group and further comprising monomers which do not exhibit a Bronsted acidic group, to co-polymerization in water, obtaining said stabilizer dispersion having a pH in the range of from 0 to 5;
(ii) preparing said aqueous polymer dispersion, comprising
(ii.1) preparing an aqueous mixture comprising water and ethylenically unsaturated monomers which do not exhibit a Bronsted acidic group;
(ii.2) introducing said aqueous mixture as a first feed into a polymerization vessel and subjecting the monomers comprised in said aqueous mixture to copolymerization in said polymerization vessel;
(ii.3) introducing the stabilizer dispersion obtained according to (i) as a second feed and a base into the polymerization vessel comprising at least a portion of said aqueous mixture, obtaining said aqueous polymer dispersion;
wherein the polymer particles of the aqueous polymer dispersion obtained according to (ii) exhibit a polymodal particle size distribution;
wherein at least 95 weight-% of the polymers comprised in the aqueous polymer dispersion are based on the monomers employed according to (i) and (ii).

17. The process of claim 16, wherein (i) comprises
(i.1) preparing a mixture of water and a surfactant under an inert gas atmosphere;
(i.2) admixing the mixture prepared according to (i.1) with an aqueous monomer mixture comprising water and ethylenically unsaturated monomers comprising monomers which exhibit a Bronsted acidic group and further comprising monomers which do not exhibit a Bronsted acidic group;
(i.3) subjecting the aqueous mixture obtained according to (i.2) to co-polymerization.

18. The process of claim 17, wherein the monomers which exhibit a Bronsted acidic group comprised in the aqueous monomer mixture used in (i.2) are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof.

19. The process of claim 16, wherein the total amount of monomers which exhibit a Bronsted acidic group comprised in the aqueous mixture obtained according to (i.2) is in the range of from 0.5 to 10 weight-% based on the total weight of the aqueous mixture obtained according to (i.2).

20. The process of claim 17, wherein the monomers which do not exhibit a Bronsted acidic group comprised in the aqueous monomer mixture used in (i.2) comprises one or more of esters of acrylic acid and esters of methacrylic acid;
wherein the esters of acrylic acid are one or more of C₁-C₁₂ alkyl esters of acrylic acid, C₅-C₂₀ cycloalkyl esters of acrylic acid and C₅-C₂₀ cycloalkylmethyl esters of acrylic acid.

21. The process of claim 17, wherein the monomers which do not exhibit a Bronsted acidic group comprised in the aqueous monomer mixture used in (i.2) comprises one or more of a monomer having a urea group and a monomer having a keto group.

22. The process of claim 17, wherein in the aqueous monomer mixture used in (i.2) the weight ratio of the monomers which exhibit a Bronsted acidic group relative to the monomers which do not exhibit a Bronsted acidic group is in the range of from 0.01:1 to 0.18:1.

23. The process of claim 16, wherein the viscosity of said stabilizer dispersion prepared according to (i) is of at most 150 mPas;
wherein the stabilizer dispersion prepared according to (i) has a solid content in the range of from 30 to 55 weight-% based on the total weight of the stabilizer dispersion prepared according to (i).

24. The process of claim 16, wherein the ethylenically unsaturated monomers which do not exhibit a Bronsted acidic group comprised in the aqueous mixture prepared according to (ii.1) comprises one or more of C₁-C₁₂ alkyl esters of acrylic acid, C₁-C₁₂ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid.

25. The process of claim 16, wherein introducing said aqueous mixture as a first feed according to (ii.2) is performed continuously into the polymerization vessel;
wherein the first feed is introduced into the polymerization vessel according to (ii.2) at a constant feed rate.

26. The process of claim 25, wherein the first feed is introduced sequentially into the polymerization vessel according to (ii.2) at different feed rates, F1-Fx, with x=2 or more, in g/h, wherein F1 (g/h)<Fx (g/h), for durations D1-Dx, respectively, wherein from 50 to 95 weight-% of the first feed are introduced at the highest feed rate Fx;
wherein, x=2, the first feed is introduced sequentially into the polymerization vessel according to (ii.2) at two different feed rates, F1 and F2, in g/h, wherein F1 (g/h)<F2 (g/h), wherein the first feed is introduced at the feed rate F1 for a duration DI in the range of from 20 to 100 minutes; or
wherein the first feed is introduced into the polymerization vessel according to (ii.2) at different feed rates, F1-Fx, with x=3 or more, in g/h, wherein one of the feed rates F1-Fx, which is not F1 or Fx, is 0 g/h for a duration in the range of from 5 to 30 minutes.

27. The process of claim 16, wherein the base is introduced according to (i.3) into the polymerization vessel prior to the second feed being the stabilizer dispersion obtained according to (i).

28. An aqueous polymer dispersion having a polymer content of at least 50 weight-% based on the total weight of the aqueous polymer dispersion obtainable or obtained by a process according to claim 16, wherein the polymer particles of the aqueous polymer dispersion exhibit a polymodal particle size distribution.

29. A method for forming a coating comprising utilizing an aqueous polymer dispersion according to claim 28 as a binder.

30. A coating composition comprising an aqueous polymer dispersion according to claim 28 and a pigment.
